(19) United States
(12) Patent Application Publication
(10) Pub. No.: US 2012/0156987 A1
(43) Pub. Date: Jun. 21, 2012

(54) WIRELESS COMMUNICATION SYSTEM, WIRELESS BASE STATION, CONTROL METHOD, AND CONTROL DEVICE

(75) Inventor: Eiji Nakayama, Daito-shi (JP)

(73) Assignee: KYOCERA CORPORATION, Kyoto-shi, Kyoto (JP)

(21) Appl. No.: 13/392,245

(22) PCT Filed: Aug. 24, 2010
(86) PCT No.: PCT/JP2010/064243

§ 371 Date: Feb. 24, 2012

(30) Foreign Application Priority Data
Aug. 26, 2009 (JP) 2009-195745
Aug. 26, 2009 (JP) 2009-195746
Aug. 26, 2009 (JP) 2009-195747

(51) Int. Cl. H04W 56/00; H04B 7/19

(52) U.S. Cl. 455/13.2

(57) ABSTRACT

Each of the plurality of wireless base stations determines whether the accuracy of a synchronizing signal generated at a corresponding synchronizing signal generation unit is below a predetermined level, and when the accuracy of synchronizing signal is below the predetermined level, refers to the management unit to determine whether there is, among other wireless base stations arranged adjacent to its own station, a wireless base station connected to a synchronizing signal generation unit differing from its own connected synchronizing signal generation unit, and when there is a wireless base station connected to a synchronizing signal generation unit differing from its own connected synchronizing signal generation unit, reducing its own transmission power.

### TECHNICAL FIELD

The present invention relates to a wireless communication system sharing a synchronizing signal between a plurality of wireless base stations, a wireless base station constituting the wireless communication system, a control method of the wireless communication system, and a control device constituting the wireless communication system.

### BACKGROUND ART

Conventionally in the field of wireless communication, an approach to improve the communication rate while increasing the usage efficiency of wireless signals has been made. As one such approach in a cell type wireless communication system, there is known the synchronization of transmission/reception timing between adjacent cells. Specifically, the transmission/reception timing between a wireless base station at a certain cell and a terminal device included in that cell is made to match the transmission/reception timing between a wireless base station at an adjacent cell and a terminal device included in that adjacent cell to suppress interference between the wireless base station and the terminal device at the adjacent cell, as well as the interference between terminal devices.

One manner of realizing synchronization of the transmission/reception timing between such cells may include the configuration of utilizing a signal from a satellite including time information. At present, a GPS (Global Positioning System) signal from a GPS satellite is known as a typical signal from a satellite including time information. Specifically, a GPS receiver to receive a GPS signal from a GPS satellite is provided at each wireless base station to synchronize the transmission/reception timing based on a GPS signal common to the wireless base stations.

Since a GPS module generating a synchronizing signal of high accuracy is relatively costly, a possible configuration is to share one GPS receiver among a plurality of wireless base stations to reduce the cost. For example, Japanese Patent Laying-Open No. 2000-232688 (Patent Literature 1) discloses a packet data communication system having each base unit coupled to a GPS receiver. In this packet data communication system, the GPS receiver receives a GPS signal from a GPS satellite, and this GPS signal serves as the common time reference.

### CITATION LIST

### Patent Literature

PTL 1: Japanese Patent Laying-Open No. 2000-232688

### SUMMARY OF INVENTION

### Technical Problem

It is to be noted that a GPS receiver may not always receive a GPS signal from a GPS satellite. There is the case where the GPS signal cannot be used as a common time reference due to various reasons such as the operation of the GPS satellite being turned off, the presence of a district where the GPS signal from the GPS satellite cannot be reached due to the planetary rotation, an error in the GPS receiver, and the like.

According to the schematic packet data communication system disclosed in Japanese Patent Laying-Open No. 2000-232688 (Patent Literature 1), a possible measure is to use some reference signal if the GPS signal cannot be used as a common time reference. However, in practice, not all the wireless base stations utilize one GPS receiver. A plurality of GPS receivers are prepared. Therefore, there will be an area where a wireless base station connected to a certain GPS receiver is adjacent to a wireless base station connected to another GPS receiver.

In the case where one of the GPS receivers cannot receive the GPS signal due to some cause, the interference may increase by the deviation in the transmission/reception timing at the area around such wireless base stations. There is a possibility that conversation and/or communication is disabled in the cell corresponding to the relevant wireless base stations.

The present invention is directed to solving the problem set forth above. An object of the present invention is to provide a wireless communication system sharing a synchronizing signal generated based on a signal from a satellite including time information among a plurality of wireless base stations, allowing degradation in the conversation/communication service to be minimized even when a signal from the satellite including time information cannot be received. Another object of the present invention is to provide a wireless base station constituting such a wireless communication system, a control method of the wireless communication system, and a control device constituting the wireless communication system.

### Solution to Problem

According to an aspect of the present invention, there is provided a wireless communication system providing conversation/communication by a terminal device. The wireless communication system includes a plurality of synchronizing signal generation units, each generating a synchronizing signal based on a signal from a satellite including time information; a plurality of wireless base stations, each connected to one of the plurality of synchronizing signal generation units to adjust the transmission/reception timing with a terminal device according to a synchronizing signal; and a management unit managing information associated with an arrangement position of the plurality of wireless base stations. The synchronizing signal includes information indicating the generation accuracy of the synchronizing signal according to the reception state at the synchronizing signal generation unit. Each of the plurality of wireless base stations determines whether the accuracy of the synchronizing signal generated at a corresponding synchronizing signal generation unit is below a predetermined level, and when the accuracy of the synchronizing signal is below the predetermined level, refers to the management unit to determine whether there is, among other wireless base stations arranged adjacent to its own station, a wireless base station connected to a synchronizing signal generation unit differing from the synchronizing signal generation unit connected its own station, and when there is a wireless base station connected to a synchronizing signal generation unit differing from the synchronizing signal generation unit connected its own station, reducing the transmission power of its own station.

According to another aspect of the present invention, there is provided a wireless communication system providing conversation/communication by a terminal device. The wireless communication system includes a synchronizing signal generation unit generating a synchronizing signal based on a signal from a satellite including time information, a plurality of wireless base stations connected to the synchronizing signal generation unit to adjust the transmission/reception timing with a terminal device according to the synchronizing signal, and a control unit controlling the transmission power of the plurality of wireless base stations. The control unit determines whether the accuracy of the synchronizing signal generated at the synchronizing signal generation unit is below a predetermined level, and when the accuracy of the synchronizing signal is below the predetermined level, obtains information indicating the communication state between the relevant wireless base station and terminal device; from each of the plurality of wireless base stations to evaluate the degree of interference, based on the obtained information indicating the communication state of each wireless base station, to adjust the transmission power of each wireless base station.

According to a further aspect of the present invention, there is provided a wireless communication system providing conversation/communication by a terminal device. The wireless communication system includes a plurality of synchronizing signal generation units, each generating a synchronizing signal based on a signal from a satellite including time information; a plurality of wireless base stations, each connected to one of the plurality of synchronizing signal generation units to adjust the transmission/reception timing with a terminal device according to a synchronizing signal; a management unit managing information associated with an arrangement position of the plurality of wireless base stations; and at least one control unit controlling the transmission power of the plurality of wireless base stations. The control unit determines whether the accuracy of the synchronizing signal generated at any of the plurality of synchronizing signal generation units is below a predetermined level, and when the accuracy of the synchronizing signal is below the predetermined level, refers to the management unit to determine whether there is, among other wireless base stations arranged adjacent to the wireless base station of interest connected to the synchronizing signal generation unit whose accuracy of the synchronizing signal is below the predetermined level, a wireless base station connected to a synchronizing signal generation unit differing from the relevant synchronizing signal generation unit, and when there is arranged adjacently a wireless base station connected to a synchronizing signal generation unit differing from the synchronizing signal generation unit whose accuracy of the synchronizing signal is below the predetermined level, instructs the wireless base station of interest to reduce the transmission power.

### Advantageous Effects of Invention

In a wireless communication system according to an embodiment of the present invention sharing a synchronizing signal generated based on a signal from a satellite including time information among a plurality of wireless base stations, degradation in conversation and/or communication service can be minimized even in the case where the signal from the satellite including time information cannot be received.

### BRIEF DESCRIPTION OF DRAWINGS

FIG. 1 is a schematic view of a configuration of a wireless communication system according to a first embodiment.

FIG. 2 is a diagram to describe occurrence of interference caused by deviation in transmission/reception timing.

FIG. 3 represents an example of a cell arrangement in a wireless communication system according to the first embodiment.

FIG. 4 represents an example of a cell arrangement according to the wireless communication system of FIG. 3 when the accuracy of a synchronizing signal falls below a predetermined level.

FIG. 5 represents an example of a hardware configuration of a wireless base station according to the first embodiment.

FIG. 6 represents an example of a processing structure of a control unit in a wireless base station according to the first embodiment.

FIG. 7 represents an example of a hardware configuration of a server device according to the first embodiment.

FIG. 8 represents an example of the contents in a domain list shown in FIG. 7.

FIG. 9 represents an example of the contents in a neighbor list shown in FIG. 7.

FIG. 10 is a flowchart representing an operation at a wireless base station according to the first embodiment.

FIG. 11 is a schematic view of a configuration of a wireless communication system according to a second embodiment.

FIG. 12 represents an example of a cell arrangement of a wireless communication system according to the second embodiment.

FIG. 13 represents an example of a cell arrangement immediately after the accuracy of a synchronizing signal falls below a predetermined level in a wireless communication system 1 shown in FIG. 12.

FIG. 14 represents an example of a cell arrangement at an elapse of a predetermined time from the fall of the accuracy of the synchronizing signal below the predetermined level at wireless communication system 1 of FIG. 12.

FIG. 15 is a diagram to describe a transmission power adjustment process at the wireless communication system according to the second embodiment.

FIG. 16 is a diagram to describe a transmission power adjustment process at the wireless communication system according to the second embodiment.

FIG. 17 represents an example of a processing structure of a control unit at a wireless base station according to the second embodiment.

FIG. 18 represents an example of a hardware configuration of a synchronizing signal generation unit according to the second embodiment.

FIG. 19 represents an example of a processing structure provided by the CPU shown in FIG. 18.

FIG. 20 represents the sequence of the processing at each element in the wireless communication system according to the second embodiment.

FIG. 21 is a flowchart of an operation at a synchronizing signal generation unit according to the second embodiment.

FIG. 22 is a schematic view representing a configuration of a wireless communication system according to a third embodiment.

FIG. 23 represents an example of a cell arrangement of the wireless communication system according to the third embodiment.

FIG. 24 represents an example of a cell arrangement according to the wireless communication system of FIG. 23 when the accuracy of a synchronizing signal falls below a predetermined level.

FIG. 25 represents an example a processing structure of a control unit at the wireless base station according to the third embodiment.

FIG. 26 represents an example of a hardware configuration of a master control unit according to the third embodiment.

FIG. 27 represents an example of a processing structure provided by the CPU shown in FIG. 26.

FIG. 28 represents the sequence of the processing at each element in the wireless communication system according to the third embodiment.

FIG. 29 is a flowchart of an operation at a control device according to the third embodiment.

FIG. 30 is a schematic view representing a configuration of a wireless communication system according to a fourth embodiment.

FIG. 31 represents an example of a cell arrangement of the wireless communication system according to the fourth embodiment.

FIG. 32 is a diagram representing a cell range when the accuracy of the synchronizing signal at a domain falls below a predetermined level at the wireless communication system shown in FIG. 31.

FIG. 33 represents an example of a hardware configuration of a control device according to the fourth embodiment.

FIG. 34 represents an example of the contents in a transmission power management list shown in FIG. 33.

FIG. 35 represents an example of update in the contents of the transmission power management list shown in FIG. 34.

FIG. 36 represents an example of a processing structure provided by the CPU shown in FIG. 33.

FIG. 37 is a flowchart of an operation at the control device according to the fourth embodiment.

### DESCRIPTION OF EMBODIMENTS

Preferred embodiments of the present invention will be described in detail with reference to the drawings. In the drawings, the same or corresponding elements have the same reference characters allotted, and description thereof will not be repeated.

### First Embodiment

<System Configuration>

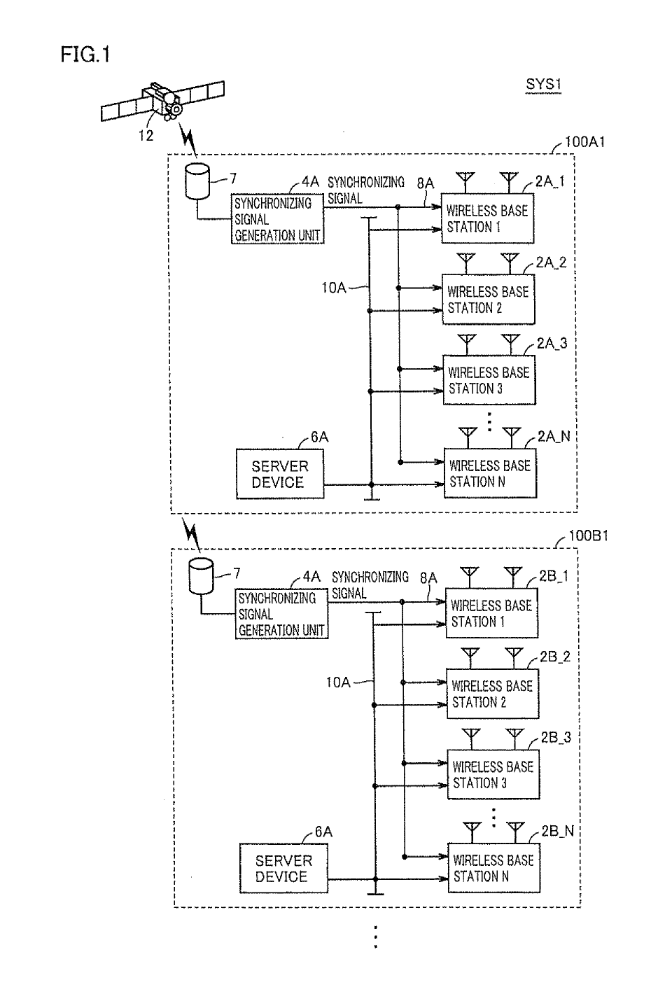

FIG. 1 is a schematic view of a configuration of a wireless communication system SYS1 according to a first embodiment. Wireless communication system SYS1 of the present embodiment is typically directed to a high speed communication system such as a cellular phone system of the TDMA (Time Division Multiple Access) scheme and CDMA (Code Division Multiple Access) scheme, a PHS (Personal Handy-phone System), the OFDMA (Orthogonal Frequency Division Multiple Access) scheme, and the like. Wireless communication system SYS1 provides conversation and/or communication by a terminal device.

Referring to FIG. 1, wireless communication system SYS1 includes a plurality of domains 100A1, 100B1 (hereinafter, also generically referred to as “domain 100”). Domain 100 is a group of wireless base stations controlling the transmission/reception timing according to a common synchronizing signal. Specifically, each domain 100 includes a plurality of wireless base stations 2, a synchronizing signal generation unit 4A, and a server device 6A. Each wireless base station shown in FIG. 1 is assigned a reference numeral of “2A_1”, “2A_2”, . . . based on a combination of the domain to which it belongs and its identification information in the relevant domain.

Although not shown in FIG. 1, each wireless base station is connected to an exchanger to transfer the audio/data received from a terminal device to the exchanger, or transferring the audio/data received from the exchanger to a designated terminal device.

At this stage, wireless base station 2 is connected to one of a plurality of synchronizing signal generation units 4A to control the transmission and reception timing of a wireless signal with a terminal device according to the synchronizing signal from the connected synchronizing signal generation unit 4A. Accordingly, interference (crosstalk) caused by deviation in the transmission/reception timing of wireless signals can be reduced at least in the cell corresponding to wireless base station 2 belonging to the same domain. A “cell” is substantially comparable to the reachable range of transmission power from a corresponding wireless base station 2.

Synchronizing signal generation unit 4A generates a synchronizing signal based on a signal from a satellite including time information. Typically, synchronizing signal generation unit 4A uses a GPS signal as a signal from a satellite including time information. At least at the time of filing the present application, development of a system similar to a GPS in a narrow sense is in progress in Europe and China. These systems are also available in the present embodiment and other embodiments set forth below. Moreover, an analogous system that may be developed in the future may also be used.

Specifically, synchronizing signal generation unit 4A includes a GPS module to receive a GPS signal from a GPS satellite 12 via an antenna 7. Synchronizing signal generation unit 4A generates a synchronizing signal that is a timing signal based on the contents (time information) of the received GPS signal. In every domain, each wireless base station 2 is connected to allow communication with a synchronizing signal generation unit 4A via a signal line 8A. Synchronizing signal generation unit 4A presents a synchronizing signal to each wireless base station 2 via signal line 8A. Signal line 8A may take any form as long as a deliberate delay time in the propagation of a synchronizing signal does not occur at each wireless base station 2. For example, a metal cable may be employed if the domain covers a relatively small communication area such as in a building or the like (the so-called micro cell or pico cell). Alternatively, an optical cable or the like may be employed if the domain covers a relatively large communication area. As to the mode of a synchronizing signal and the procedure for synchronization, the standard protocol for synchronization defined in IEEE (The Institute of Electrical and Electronics Engineers, Inc.) 1588 may be employed.

The synchronizing signal is added with information indicating the generation accuracy of the synchronizing signal according to the reception state at synchronizing signal generation unit 4A, as will be described afterwards. As used herein, generation accuracy of a synchronizing signal typically implies the deviation from the essential synchronizing timing, i.e. the degree in timing difference.

Each wireless base station 2 is connected to server device 6A in an accessible manner via a data line 10A. Server device 6A is comparable to a management unit managing information associated with the arrangement position of a plurality of wireless base stations 2. Specifically, server device 6A holds a domain list (information of the domain to which each wireless base station belongs) and a neighbor list (information of adjacent station). When the accuracy of the synchronizing signal generated at synchronizing signal generation unit 4A falls below a predetermined level, wireless base station 2 obtains the required information from server device 6A to perform control to suppress interference with another wireless base station, as will be described afterwards. Although any type may be employed for data line 10A, typically the data communication system of the Ethernet (registered trademark) and the like can be employed.

FIG. 1 corresponds to an example of a configuration having server device 6A arranged for every domain. Alternatively, a configuration in which a common server device 6A is shared among a plurality of domains may be employed. In the case where server device 6A is arranged for every domain, synchronizing signal generation unit 4A and server device 6A may be integrated into one main unit for every domain.

<Interference and Suppression Method Thereof>

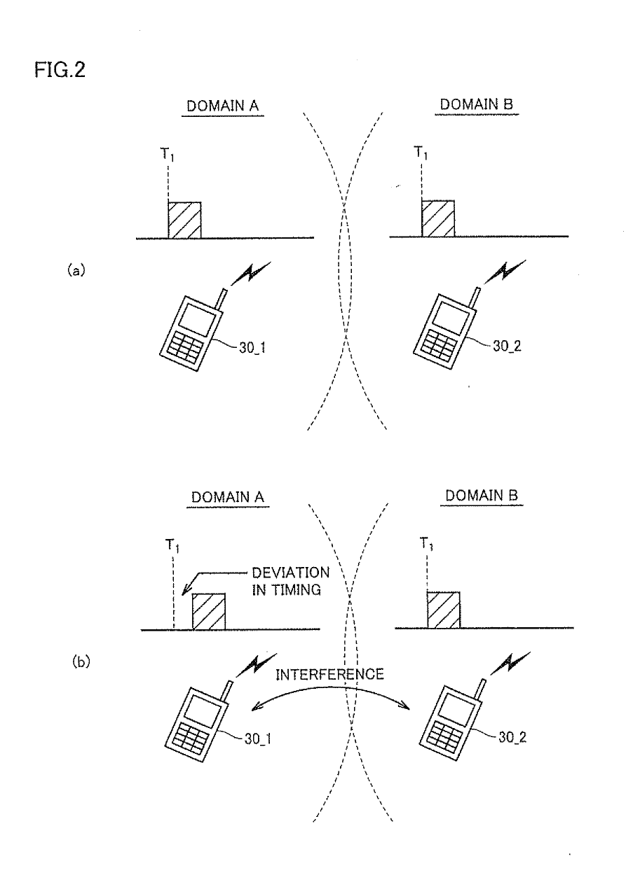

Referring to FIGS. 2-4, interference occurring when a GPS signal cannot be received properly at synchronizing signal generation unit 4A (FIG. 1), and a method of suppression thereof will be described hereinafter.

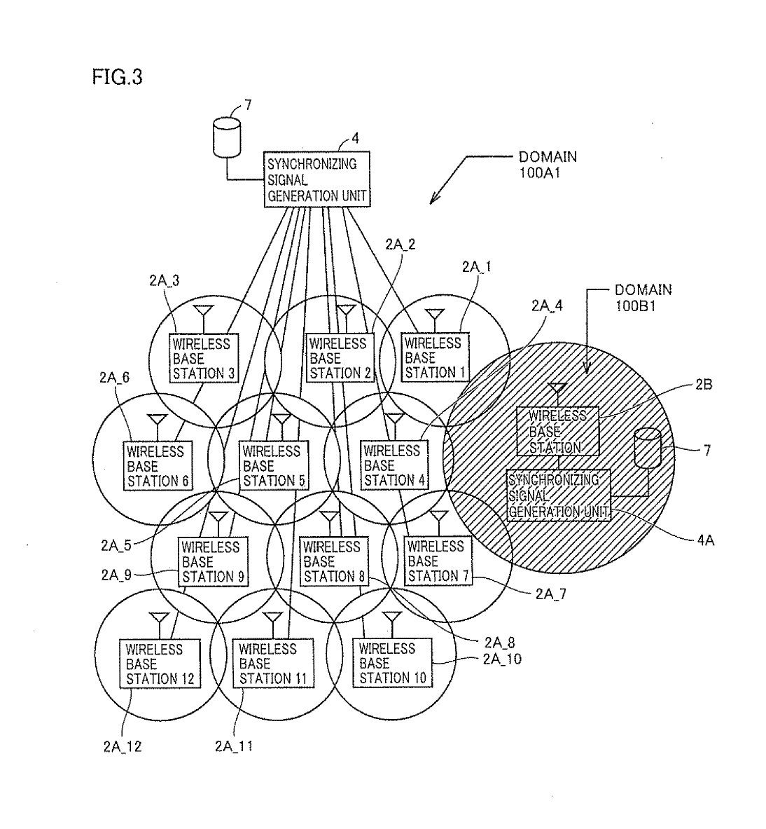

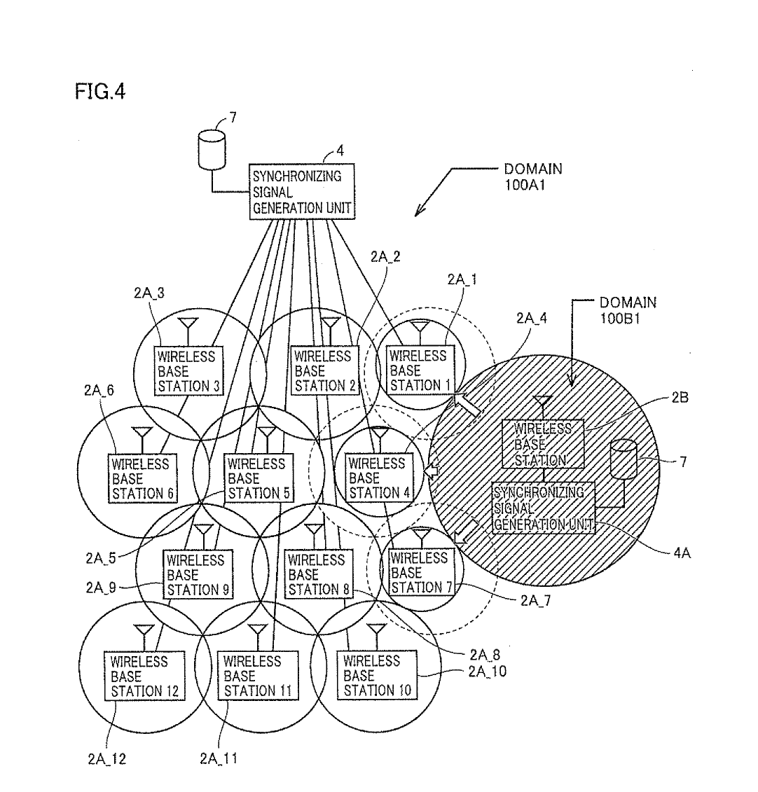

FIG. 2 is a diagram to describe occurrence of interference caused by deviation in the transmission/reception timing. FIG. 3 represents an example of a cell arrangement of the wireless communication system according to the first embodiment. FIG. 4 represents an example of a cell arrangement when the accuracy of the synchronizing signal falls below a predetermined level at the wireless communication system shown in FIG. 3.

First, let us consider a cell in the proximity of the border between two domains. Specifically, it is assumed that a cell range (referred to as “domain A”) covered by a wireless base station 2 operating according to a synchronizing signal from a certain synchronizing signal generation unit 4A is adjacent to a cell range (referred to as “domain B”) covered by a wireless base station 2 operating according to a synchronizing signal from another synchronizing signal generation unit 4A.

When synchronizing signal generation unit 4A belonging to domain A and synchronizing signal generation unit 4A belonging to domain B receive the same GPS signal, the transmission/reception timing between all wireless base stations 2 belonging to domain A and domain B is synchronized since substantially the same synchronizing signal is generated between domain A and domain B. Therefore, a terminal device 30_1 located in the cell of domain A and a terminal device 30_2 located in the cell of domain B transmit or receive a wireless signal at the same timing (time T1 shown in FIG. 2 (a)). Accordingly, interference (crosstalk) between terminal device 30_1 and terminal device 30_2 can be reduced.

When synchronizing signal generation unit 4A belonging to domain A is not able to receive a GPS signal, deviation will occur between the synchronizing signal used at domain A and the synchronizing signal used at domain B. Therefore, terminal device 30_1 located in the cell of domain A and terminal device 30_2 located in the cell of domain B will transmit or receive a wireless signal at different timing. As a result, interference (crosstalk) occurs between terminal device 30_1 and terminal device 30_2. Specifically, the wireless signal transmitted by terminal device 30_2 will be received during the reception period of terminal device 301, such that the wireless signal from terminal device 30_2 will become the radio interference (FIG. 2 (b)).

When synchronization of the transmission/reception timing cannot be established at the wireless communication system of the present embodiment, each wireless base station adjusts the cell range so as to suppress occurrence of interference.

The wireless communication system shown in FIG. 3 will be described by way of example. In the wireless communication system of FIG. 3, twelve wireless base stations 2A_1 to 2A_12 belong to domain 100A1, and one wireless base station 2B belongs to domain 100B1. It is now assumed that synchronizing signal generation unit 4A of domain 100A1 is disabled from properly receiving a GPS signal.

At this stage, a wireless base station adjacent to only a wireless base station belonging to the common domain 100A1 is not affected by the transmission/reception timing of domain 131. In view of wireless base station 2A_2, for example, four wireless base stations 2A_1, 2A_3, 2A_4 and 2A_5 are located adjacently, all belonging to domain 100A1. Therefore, even if the synchronizing signal used at domain 100A1 is deviated from the synchronizing signal used at domain 100B1, interference will not occur between wireless base stations 2A_1 to 2A_5.

In contrast, wireless base station 2A_1 is adjacent to two wireless base stations 2A_2 and 2A_4 belonging to domain 100A1, as well as to a wireless base station 213 belonging to domain 100B1. Therefore, if the synchronizing signal used at domain 100A1 is deviated from the synchronizing signal used at domain 100B1, interference will occur between wireless base station 2A_1 and wireless base station 2B.

In such an event, the wireless communication system according to the present embodiment narrows the cell range through each wireless base station 2 reducing or cutting its own transmission power. Specifically, as shown in FIG. 4, each of wireless base stations 2A_1, 2A_4, and 2A_7 adjacent to wireless base station 213 belonging to domain 100B1, among wireless base stations 2 belonging to domain 100A1, narrows its own cell range to a range that does not overlap with the cell range of wireless base station B.

Namely, wireless base station 2A_1 reduces its own transmission power to avoid overlapping with the reachable range (hatched region) of the transmission power of adjacent wireless base station 2B connected to synchronizing signal generation unit 4A differing from synchronizing signal generation unit 4A connected to its own station.

Thus, interference with a terminal device located across a different domain can be reduced. By such processing, the area where the conversation and/or communication service is stopped can be made as small as possible even in the case where a GPS signal cannot be received properly, i.e. even in the case where the accuracy of the synchronizing signal generated by synchronizing signal generation unit 4A is not ensured.

<Configuration of Wireless Base Station>

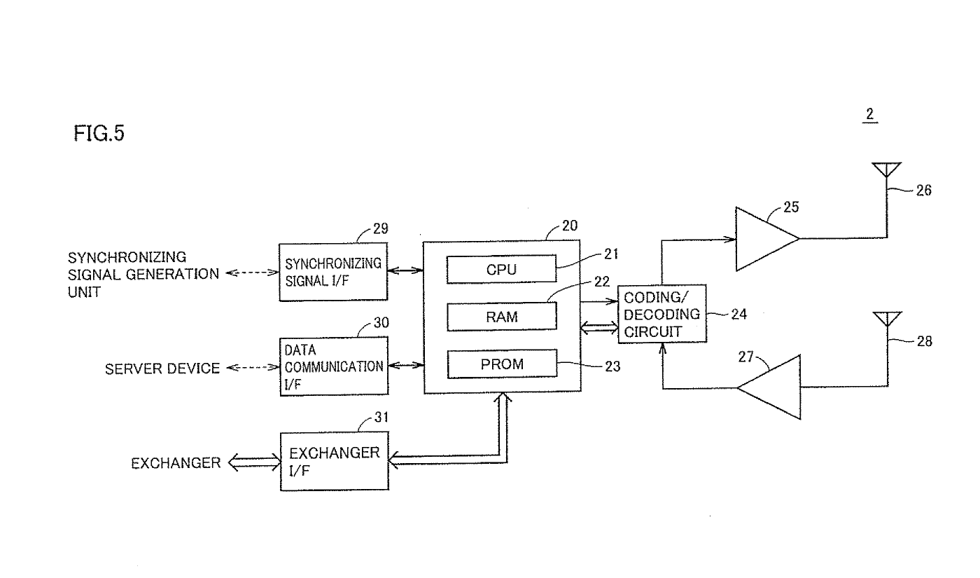

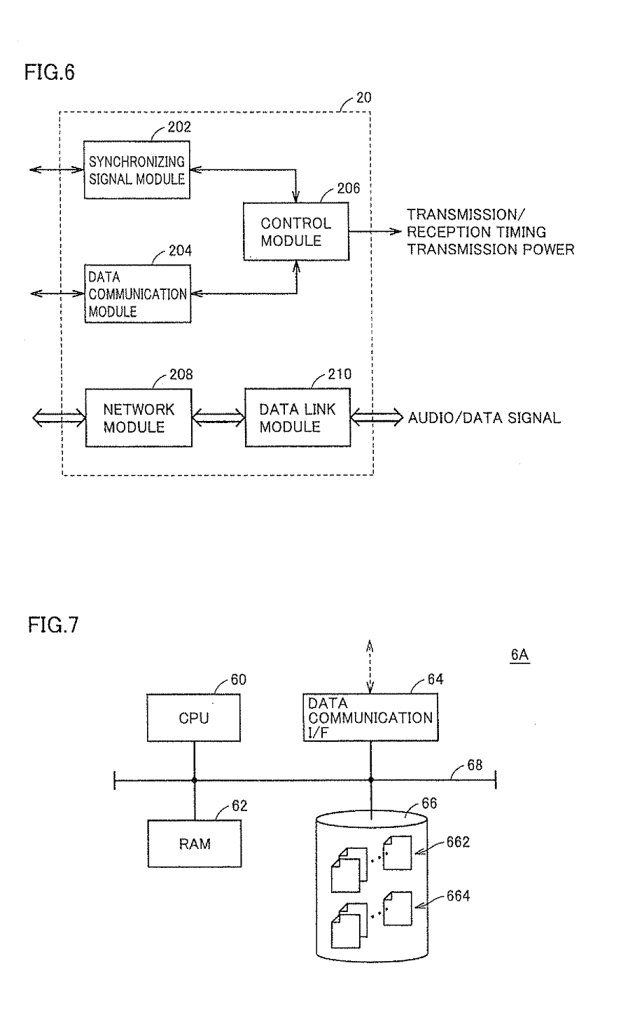

A configuration of a wireless base station 2 according to the present embodiment will be described hereinafter with reference to FIGS. 5 and 6.

FIG. 5 represents an example of a hardware configuration of a wireless base station 2 according to the first embodiment. FIG. 6 represents an example of a processing structure of a control unit 20 in wireless base station 2 according to the first embodiment.

Referring to FIG. 5, wireless base station 2 of the present embodiment includes a control unit 20, a coding/decoding circuit 24, an up converter 25, a transmission antenna 26, a down converter 27, a reception antenna 28, a synchronizing signal interface (hereinafter, referred to as “synchronizing signal I/F”) 29, a data communication interface (hereinafter, referred to as “data communication I/F”) 30, and an exchanger interface (hereinafter, referred to as “exchanger I/F”) 31.

Wireless base station 2 controls the transmission/reception timing with a terminal device according to a synchronizing signal received from synchronizing signal generation unit 4A (FIG. 1). Wireless base station 2 also transfers audio/data to/from an exchanger not shown, performs a registration process of position information for a terminal device in the cell, and the like.

Control unit 20 is a processing main unit executing the major processing in wireless base station 2 described above, and includes a CPU (Central Processing Unit) 21, a RAM (Random Access Memory) 22, and a PROM (Programmable Read Only Memory) 23. CPU 21 that is an operation device transfers the program code prestored in PROM 23 or the like to RAM 22 to execute various processing according to the relevant program code. RAM 22 stores, in addition to the program code executed at CPU 21, various word data required for the execution of the program code. A program code as well as various constants executed at CPU 21 are stored in advance at PROM 23.

Control unit 20 is connected to coding/decoding circuit 24 to instruct coding/decoding circuit 24 on the transmission/reception timing and transmission power.

Coding/decoding circuit 24 assumes the physical layer function in the so-called OSI (Open Systems Interconnection) model. Specifically, coding/decoding circuit 24 executes a predetermined coding process and modulation process in response to receiving a stream of data to be transmitted from control unit 20 to output the generated signal to up converter 25. Up converter 25 converts the frequency (up-convert) the signal received from coding/decoding circuit 24 into a wireless signal to be transmitted to a terminal device, and provides the converted signal to connected transmission antenna 26.

In contrast, a wireless signal received from a terminal device is input to down converter 27 via a reception antenna 28. Down converter 27 converts the frequency (down-convert) of the received wireless signal, and provides the generated signal to coding/decoding circuit 24. Coding/decoding circuit 24 executes a decoding process on the signal from down converter 27, and provides the decoded data to control unit 20.

Coding/decoding circuit 24 adjusts the transmission of a wireless signal (signal output to up converter 25) and reception of a wireless signal (input of a signal from down converter 27) according to the transmission/reception timing designated by control unit 20. Furthermore, coding/decoding circuit 24 adjusts the power of a wireless signal (the strength of the signal applied to up converter 25) conveyed from transmission antenna 26, according to the transmission power designated by control unit 20.

Synchronizing signal I/F 29 is connected to control unit 20 to receive a synchronizing signal transmitted from synchronizing signal generation unit 4A, and applies the received contents to control unit 20. Data communication I/F 30 is connected to control unit 20 to provide access to server device 6A (FIG. 1). Exchanger I/F 31 is connected to control unit 20 to provide transfer of audio/data and the like with an exchanger not shown.

The mounted form of wireless base station 2 is not limited to the hardware shown in FIG. 5. Rather, an appropriate hardware configuration is selected according to the scale of wireless base station 2 (the cell range, the maximum numbers that can be connected at the same time, and the like).

Referring to FIG. 6, control unit 20 includes, as a processing structure, a synchronizing signal module 202, a data communication module 204, a control module 206, a network module 208, and a data link module 210.

Synchronizing signal module 202 applies an internal instruction to control module 206 based on the synchronizing signal from synchronizing signal generation unit 4A received via synchronizing signal I/F 29.

Data communication module 204 responds to an internal instruction from control module 206 to request, via data communication I/F 30 (FIG. 5), the required data from server device 6A (FIG. 1), and receives the returned data transmitted from server device 6A to provide the result to control module 206.

Control module 206 applies the transmission/reception timing to coding/decoding circuit 24 (FIG. 5) based on an internal instruction from synchronizing signal module 202. Namely, synchronizing signal module 202 and control module 206 adjust the transmission/reception timing with a terminal device according to the synchronizing signal.

Furthermore, control module 206 determines whether the accuracy of the synchronizing signal generated at the connected synchronizing signal generation unit 4A maintains a predetermined level or not. Namely, control module 206 presents the function to determine whether the accuracy of the synchronizing signal generated at corresponding synchronizing signal generation unit 4A is below a predetermined level or not.

When a determination is made that the accuracy of the synchronizing signal is below the predetermined level, control module 206 provides an internal instruction to data communication module 204 to obtain information about other wireless base stations adjacent to its own station from server device 6A (FIG. 1). Then, control module 206 determines whether another neighboring wireless base station 2 belongs to another domain or not. Specifically, when the accuracy of the synchronizing signal is below the predetermined level, control module 206 refers to server device 6A functioning as a management unit to determine whether there is, among other wireless base stations 2 arranged adjacently to its own station, a wireless base station 2 connected to a synchronizing signal generation unit 4A differing from its own connected synchronizing signal generation unit 4A.

Moreover, in the case where the another neighboring wireless base station belongs to another domain, control module 206 notifies reduction or cutting (modification of the transmission intensity) of the transmission power to narrow the cell range of its own station. In other words, control module 206 presents the function to lower the transmission power of its own station when there is arranged adjacently a wireless base station 2 connected to a synchronizing signal generation unit 4A differing from its own connected synchronizing signal generation unit 4A.

Network module 208 assumes the network layer function of the so-called OSI model. In other words, network module 208 performs routing and the like of audio/data transferred between the exchanger and a terminal device.

Data link module 210 assumes the data link layer function of the so-called OSI model. In other words, data link module 210 controls the delivery of a signal between a wireless base station 2 (FIG. 1) and a terminal device.

<Synchronizing Signal Generation Unit>

It is assumed that synchronizing signal generation unit 4A according to the present embodiment generates a synchronizing signal based on a GPS signal received from GPS satellite 12, and can generate, even when reception of a GPS signal is interrupted, a synchronizing signal having an accuracy of a level identical to that of a synchronizing signal based on a GPS signal for a predetermined period. Such a function is referred to as the “hold over” function. For example, synchronizing signal generation unit 4A can continuously generate a synchronizing signal for a period of approximately 24 hours even if a GPS signal cannot be received.

Although a GPS module having such a hold over function is relatively costly, a configuration in which one synchronizing signal generation unit 4A is shared among a plurality of wireless base stations 2, as in the wireless communication system of the present embodiment, allows a GPS module with a hold over function, having high accuracy and reliability, to be employed while suppressing the entire cost of the system.

It is to be noted that synchronizing signal generation unit 4A will not be able to generate a synchronizing signal at a timing identical to that of a synchronizing signal generation unit 4A of another domain unless a GPS signal is received within a predetermined period, even if such a hold over function is provided.

Synchronizing signal generation unit 4A according to the present embodiment outputs a synchronizing signal in which is contained information indicating the generation accuracy of the relevant synchronizing signal according to the reception state at synchronizing signal generation unit 4A (currently receiving GPS properly, in hold over state, out of hold over state), in addition to the information indicating its own generated timing. Each wireless base station 2 receiving this synchronizing signal can identify the accuracy of the synchronizing signal generated at its connected synchronizing signal generation unit 4A.

The generation accuracy of a synchronizing signal may be degraded due to some cause even in the case where a GPS signal is received properly. Therefore, the generation accuracy of a synchronizing signal may be evaluated based on the variation (dispersion) of jitter in the synchronizing signal generated at synchronizing signal generation unit 4A. In this case, information indicating the generation accuracy of a synchronizing signal may include information indicating that the synchronizing signal accuracy has fallen below a predetermined level, and/or a value of the accuracy of the synchronizing signal.

<Configuration of Server Device>

A configuration of server device 6A according to the present embodiment will be described hereinafter with reference to FIGS. 7-9.

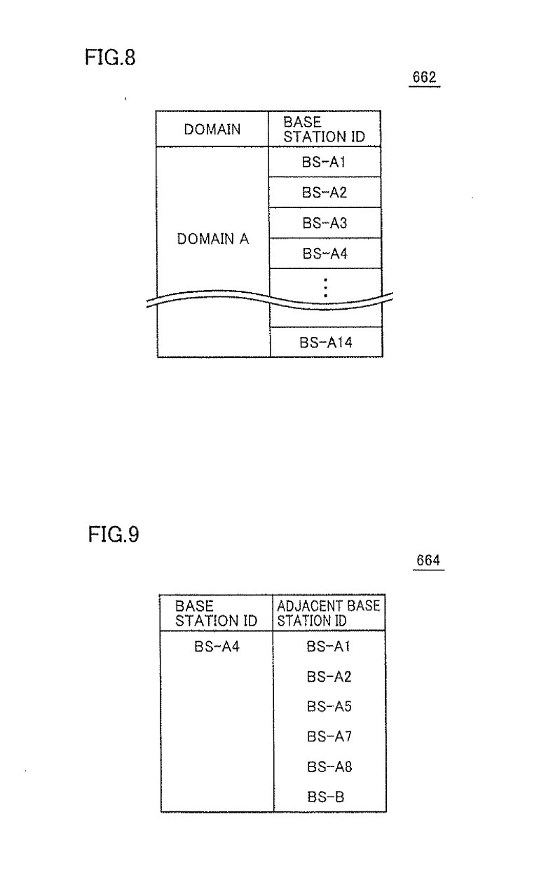

FIG. 7 represents an example of a hardware configuration of server device 6A according to the first embodiment. FIG. 8 represents an example of the contents in the domain list shown in FIG. 7. FIG. 9 represents an example of the contents in the neighbor list shown in FIG. 7.

Referring to FIG. 7, server device 6A according to the present embodiment includes a CPU 60, a RAM 62, a data communication interface (hereinafter, referred to as “data communication I/F”) 64, and a data storage unit 66. Each of these elements is configured to allow data communication with each other via an internal bus 68.

CPU 60 that is an operation device transfers a prestored program code into RAM 62 to execute various processing according to the relevant program code. RAM 62 stores, in addition to the program code executed by CPU 60, various work data required for the execution of a program code.

Data communication I/F 64 provides the access from each wireless base station 2.

Data storage unit 66 is typically a hard disk device or the like, storing a domain list 662 and a neighbor list 664. Upon receiving data access from any wireless base station 2 via data communication I/F 64, CPU 60 refers to domain list 662 and neighbor list 664 in data storage unit 66 to return the required data.

Domain list 662 includes information defining the correspondence between each synchronizing signal generation unit 4A and a wireless base station 2 connected to the relevant synchronizing signal generation unit 4A. In other words, domain list 662 includes information to identify a wireless base station 2 belonging to each domain. As shown in FIG. 8, domain list 662 is typically a table including “domain” and “base station ID” set corresponding to a relevant domain. In the column of “domain”, identification information to identify each domain such as “domain A” and “domain B” is described. In the column of “base station ID”, identification information to identify a wireless base station belonging to a corresponding domain such as “BS-A1” and “BS-A2”is described.

Neighbor list 664 includes information defining the correspondence between each wireless base station 2 and another wireless base station 2 adjacent to the relevant wireless base station 2. Specifically, neighbor list 664 includes information, for each wireless base station 2, to identify another wireless base station 2 adjacent to relevant wireless base station 2. As shown in FIG. 9, neighbor list 664 is typically a table including “base station ID” that is the identification information indicating a wireless base station 2 of interest, and “adjacent base station ID” that is the identification information indicating a wireless base station 2 arranged adjacent to the relevant wireless base station 2. In the column of “base station ID”, identification information specifying a wireless base station 2 such as “BS-A4” is described. Moreover, in the column of “adjacent base station ID”, identification information is described to specify a wireless base station arranged adjacent to a corresponding wireless base station 2, such as “BS-A1” and “BS-A2”. The contents in neighbor list 664 shown in FIG. 8 are set in correspondence relative to FIG. 3 and FIG. 4 set forth above.

It is assumed that domain list 662 and neighbor list 664 are updated every time an adding/modification/deleting, or the like is carried out at a wireless base station 2 in the wireless communication system.

<Processing Procedure>

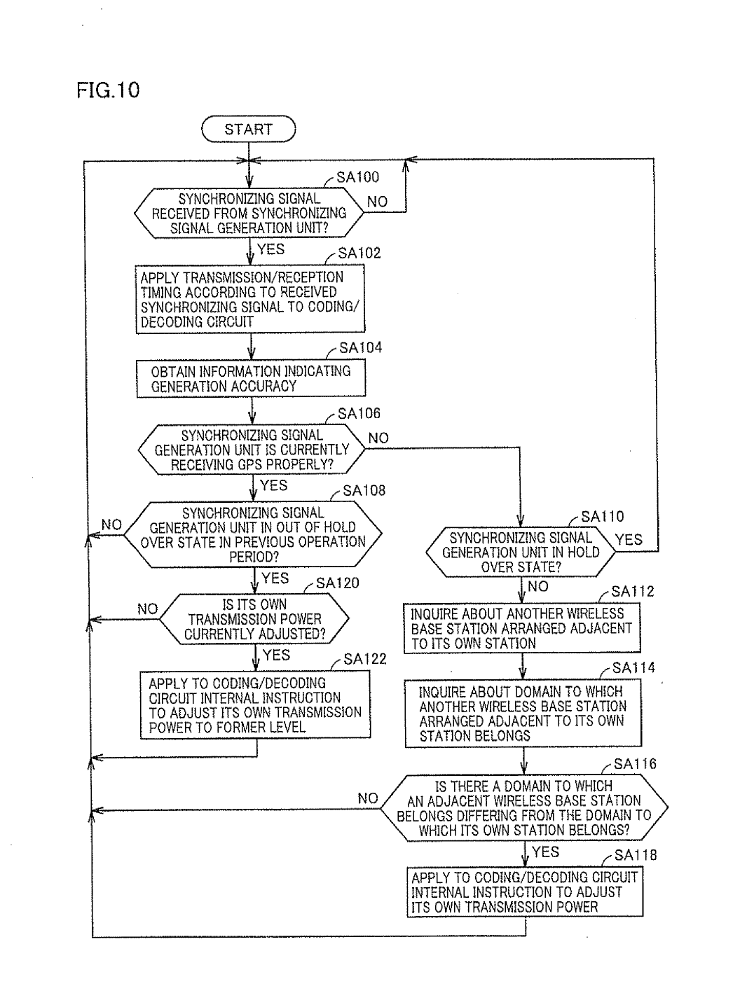

An operation at wireless base station 2 of the wireless communication system according to the present embodiment will be described hereinafter with reference to FIG. 10.

FIG. 10 is a flowchart of an operation at wireless base station 2 according to the first embodiment.

Referring to FIG. 10, control unit 20 (FIG. 5) of wireless base station 2 determines whether a synchronizing signal is received or not from synchronizing signal generation unit 4A (FIG. 1) (step SA100). If a synchronizing signal is not received (NO at step SA100), the process of step SA100 is repeated.

In contrast, if a synchronizing signal is received (YES at step SA100), control unit 20 applies the transmission/reception timing according to a received synchronizing signal to coding/decoding circuit 24 (FIG. 5) (step SA102). In other words, control unit 20 adjusts the transmission/reception timing with a terminal device according to the synchronizing signal from its connected synchronizing signal generation unit 4A.

Then, control unit 20 obtains information indicating the generation accuracy of a synchronizing signal included in the received synchronizing signal (step SA104). Control unit 20 determines whether synchronizing signal generation unit 4A is currently receiving GPS properly (step SA106). In other words, control unit 20 determines whether the accuracy of the synchronizing signal generated at corresponding synchronizing signal generation unit 4A is below a predetermined level.

In the case where synchronizing signal generation unit 4A is currently receiving GPS properly (YES at step SA106), control unit 20 determines whether synchronizing signal generation unit 4A was out of a hold over state in the previous operation period (step SA108). Namely, control unit 20 determines whether the accuracy of the synchronizing signal generated at corresponding synchronizing signal generation unit 4A has recovered to the predetermined level after falling below the predetermined level. In other words, control unit 20 determines whether reception of a GPS signal has resumed or not by synchronizing signal generation unit 4A in an out of hold over state.

In the case where synchronizing signal generation unit 4A is in an out of hold over state in the previous operation period (YES at step SA108), control proceeds to step SA120. In contrast, when synchronizing signal generation unit 4A is not in an out of hold over state in the previous operation period (NO at step SA108), the subsequent processing is skipped, and the processing of steps SA100 and et seq. is repeated.

In the ease where synchronizing signal generation unit 4A is not currently receiving GPS properly (NO at step SA106), control unit 20 determines whether synchronizing signal generation unit 4A is in a hold over state (step SA110). When synchronizing signal generation unit 4A is in a hold over state (YES at step SA110), the subsequent processing is skipped, and the processing of steps SA100 and et seq. is repeated.

In the case where synchronizing signal generation unit 4A is not in a hold over state (NO at step SA110), i.e. synchronizing signal generation unit 4A is in an out of hold over state, control unit 20 executes the transmission power adjustment processing set forth below.

First, control unit 20 inquires of server device 6A about another wireless base station arranged adjacent to its own station (step SA112). More specifically, when control unit 20 transmits the identification information of its own station to server device 6A, CPU. 60 of server device 6A refers to neighbor list 664 stored in data storage unit 66 to return identification information of an adjacent base station corresponding to the inquired identification information. Specifically, control unit 20 refers to neighbor list 664 of server device 6A to identify another wireless base station adjacent to its own station.

Then, control unit 20 inquires of server device 6A about the domain to which each another wireless base station arranged adjacent to its own station belongs (step SA114). Specifically, following the transmission of the identification information of an adjacent wireless base station obtained by control unit 20 to server device 6A, CPU 60 of server device 6A refers to domain list 662 stored in data storage unit 66 to return the identification information of a domain corresponding to the inquired identification information. Namely, control unit 20 refers to domain list 662 of server device 6A to identify synchronizing signal generation unit 4A connected to another wireless base station adjacent to its own station obtained at step SA112.

Then, control unit 20 determines whether there is a domain to which an adjacent wireless base station belongs that differs from the domain to which its own station belongs (step SA116). Namely, control unit 20 determines whether any wireless base station adjacent to its own station belongs to a domain differing from that of its own station.

As shown in steps SA112-SA116 set forth above, in the case where the accuracy of the synchronizing signal is below a predetermined level, control unit 20 refers to server device 6A. to determine whether there is, among other wireless base stations 2 arranged adjacent to its own station, a wireless base station 2 connected to a synchronizing signal generation unit 4A differing from its own connected synchronizing signal generation unit 4A.

If the domain to which an adjacent wireless base station belongs does not differ from the domain to which its own station belongs (NO at step SA116), the subsequent processing is skipped, and the processing of steps SA100 and et seq. is repeated. In other words, when there is not a wireless base station 2 connected to a synchronizing signal generation unit 4A differing from its own connected synchronizing signal generation unit 4A, control unit 20 maintains the transmission power of its own station.

In contrast, when there is a domain to which an adjacent wireless base station belongs that differs from the domain to which it belongs (YES at step SA116), control unit 20 applies to coding/decoding circuit 24 (FIG. 5) an internal instruction to adjust the transmission power of its own station in order to suppress interference with another wireless base station belonging to another domain (step SA118). In other words, when there is a wireless base station 2 connected to a synchronizing signal generation unit 4A differing from its own connected synchronizing signal generation unit 4A, control unit 20 reduces the transmission power of its own station. Then, the processing of steps SA100 and et seq. is repeated.

The transmission power adjustment processing at step SA118 is performed to avoid interference with an adjacent wireless base station 2 belonging to a domain differing from that of its own station. In other words, control unit 20 reduces the transmission power of its own station to avoid overlapping with a reachable range of transmission power of an adjacent wireless base station 2, connected to a synchronizing signal generation unit 4A differing from synchronizing signal generation unit 4A connected to its own station.

Therefore, the transmission power subsequent to reduction may be determined dynamically based on the distance from an adjacent wireless base station belonging to a domain differing from that of its own wireless base station and the transmission power of the relevant adjacent wireless base station. Alternatively, a distance that does not cause interference with an adjacent wireless base station (transmission power) may be determined in advance, and have the transmission power lowered down to this predetermined value (for example, ½ the general transmission power). Further alternatively, the transmission power may be set to zero (output stopped) such that interference with the relevant adjacent wireless base station is completely prevented.

At step SA120, control unit 20 determines whether the transmission power of its own station is currently being adjusted or not. If the transmission power of its own station is being adjusted (YES at step SA120), control unit 20 applies to coding/decoding circuit 24 (FIG. 5) an internal instruction to adjust the transmission power of its own station to the former level in response to the recovery of the synchronizing signal to the proper state (step SAl22). In other words, when the accuracy of the synchronizing signal recovers to the predetermined level, control unit 20 restores the lowered transmission power of its own station to the former level. Then, the processing of steps SA100 and et seq. is repeated.

If the transmission power of its own station is not currently adjusted (NO at step SA120), the processing of steps SA100 and et seq. is repeated.

Since a plurality of wireless base stations share a synchronizing signal generation unit that generates a synchronizing signal according to a wireless communication system of the present embodiment, a GPS module of further high accuracy and reliability while suppressing the entire cost of the system can be employed.

Even in the case where a synchronizing signal generation unit cannot receive a signal (for example, GPS signal) from a satellite including time information due to some cause and the accuracy of the generated synchronizing signal cannot be maintained in the wireless communication system of the present embodiment, the transmission power can be adjusted to suppress interference with a wireless base station connected to another synchronizing signal generation unit. As a result, conversation and/or communication service can be continued to the best possible degree even in the case where the accuracy of synchronizing signal cannot be ensured.

<Other Formats>

According to the present embodiment, there is provided a wireless base station constituting a wireless communication system providing conversation/communication by a terminal device. The wireless base station includes an adjustment unit connected to one of a plurality of synchronizing signal generation units to adjust the transmission/reception timing with a terminal device according to a synchronizing signal from a synchronizing signal generation unit of the connecting party. Each of the plurality of synchronizing signal generation units generates a synchronizing signal based on a signal from a satellite including time information. The synchronizing signal includes information indicating the generation accuracy of a synchronizing signal according to the reception state of the corresponding synchronizing signal generation unit. The wireless base station determines whether the accuracy of a synchronizing signal generated at a corresponding synchronizing signal generation unit is below a predetermined level, and when the accuracy of the synchronizing signal is below the predetermined level, refers to the management unit managing information associated an arrangement position of a wireless base station included in the wireless communication system to determine whether there is, among other wireless base stations arranged adjacent to its own station, a wireless base station connected to a synchronizing signal generation unit differing from its own connected synchronizing signal generation unit, and when there is a wireless base station connected to a synchronizing signal generation unit differing from its own connected synchronizing signal generation unit, reduces the transmission power of its own station.

According to the present embodiment, there is provided a control method of a wireless communication system providing conversation/communication by a terminal device. The control method includes the steps of: each of a plurality of synchronizing signal generation units generating a synchronizing signal based on a signal from a satellite including time information; each of the plurality of synchronizing signal generation units adjusting transmission/reception timing with a terminal device according to a synchronizing signal from one of connected plurality of synchronizing signal generation units; each of the plurality of wireless base stations determining whether the accuracy of a synchronizing signal generated at a corresponding synchronizing signal generation unit is below a predetermined level, based on information indicating generation accuracy of a synchronizing signal included in the received synchronizing signal; when the synchronizing signal accuracy is below the predetermined level, each of the plurality of wireless base stations referring to a management device managing information associated with an arrangement position of a wireless base station included in the wireless communication system to determine whether there is, among other wireless base stations arranged adjacent to its own station, a wireless base station connected to a synchronizing signal generation unit differing from its own connected synchronizing signal generation unit; and when there is a wireless base station connected to a synchronizing signal generation unit differing from its own connected synchronizing signal generation unit, each of the plurality of wireless base stations reducing the transmission power of its own station.

### Second Embodiment

<System Configuration>

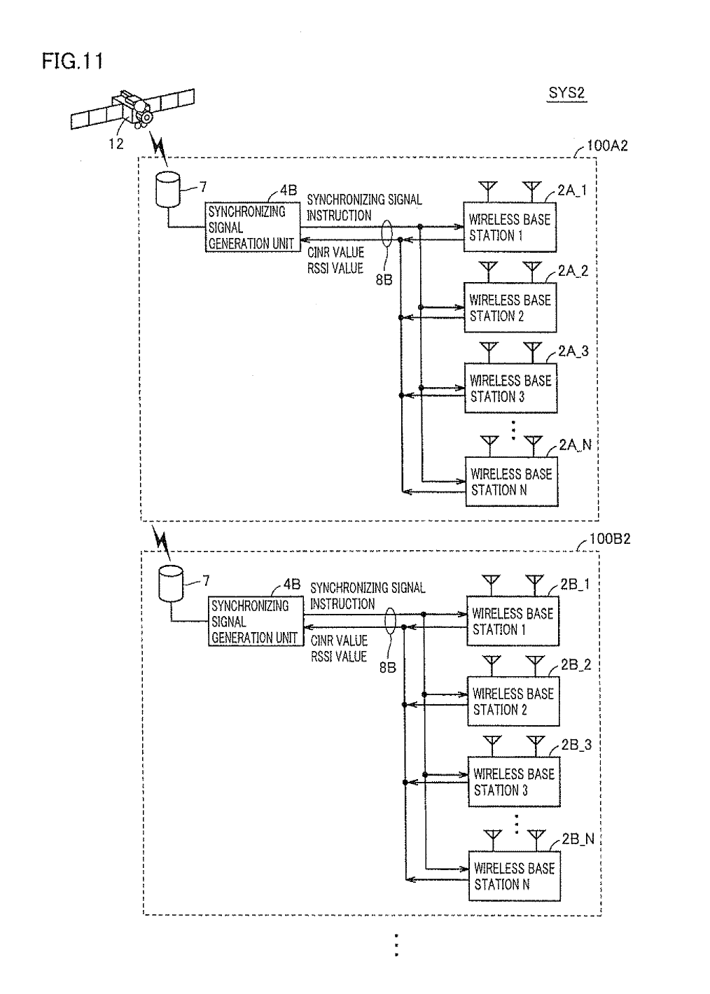

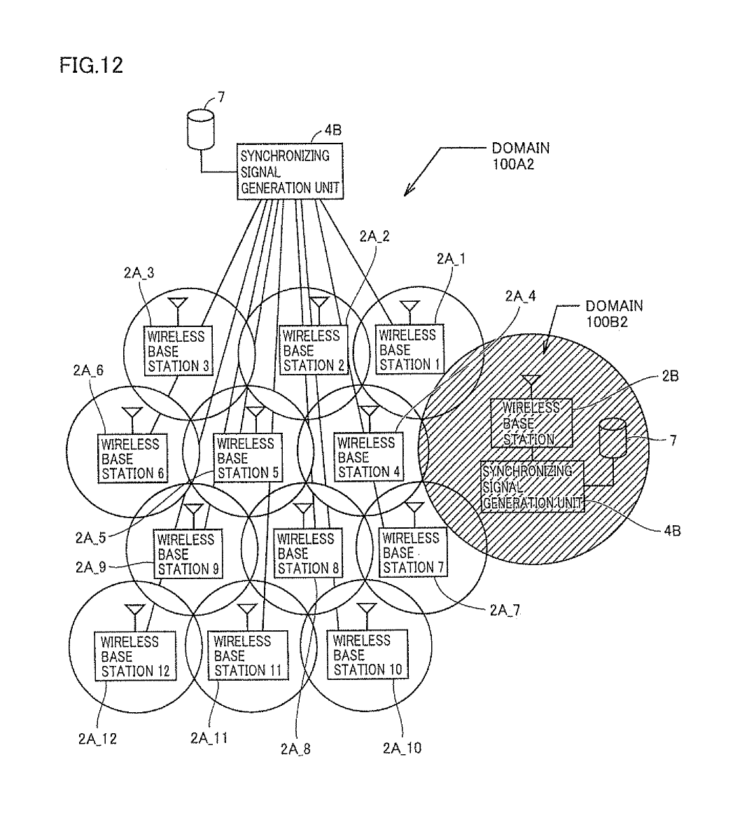

FIG. 11 is a schematic view of a configuration of a wireless communication system SYS2 according to a second embodiment. Wireless communication system SYS2 of the present embodiment is typically directed to a high speed data communication system such as a cellular phone system of the TDMA scheme and CDMA scheme, a PHS system, the OFDMA scheme, and the like. Namely, wireless communication system SYS2 provides conversation and/or communication by a terminal device.

Referring to FIG. 11, wireless communication system SYS2 includes a plurality of domains 100A2, 100B2 (hereinafter, also generically referred to as “domain 100”). Domain 100 is a group of wireless base stations controlling the transmission/reception timing according to a common synchronizing signal. Specifically, each domain 100 includes a plurality of wireless base stations 2, and a synchronizing signal generation unit 4B that is a control device of wireless base stations 2.

Each wireless base station shown in FIG. 11 is assigned a reference numeral of “2A_1”, “2A_2”, . . . based on a combination of the domain to which it belongs and its identification information in the relevant domain.

Although not shown in FIG. 11, each wireless base station 2 is connected to an exchanger to transfer the audio/data received from a terminal device to the exchanger, or transferring the audio/data received from the exchanger to a designated terminal device.

At this stage, wireless base station 2 is connected to one of a plurality of synchronizing signal generation units 4B to control the transmission and reception timing of a wireless signal with a terminal device according to the synchronizing signal from the connected synchronizing signal generation unit 4B. Accordingly, interference (crosstalk) caused by deviation in the transmission/reception timing of wireless signals can be reduced at least in the cell corresponding to wireless base station 2 belonging to the same domain 100. A “cell” is substantially comparable to the reachable range of transmission power from a corresponding wireless base station 2.

Synchronizing signal generation unit 4B generates a synchronizing signal based on a signal from a satellite including time information. Typically, synchronizing signal generation unit 4B uses a GPS signal as a signal from a satellite including time information. Specifically, synchronizing signal generation unit 4B includes a GPS module (GPS module 43 shown in FIG. 10) to receive a GPS signal from a GPS satellite 12 via an antenna 7. Synchronizing signal generation unit 4B generates a synchronizing signal that is a timing signal based on the contents (time information) of the received GPS signal. In every domain 100, each wireless base station 2 is connected to allow communication with a synchronizing signal generation unit 4B via a signal line 8B. Synchronizing signal generation unit 4B presents a synchronizing signal to each wireless base station 2 via signal line 8B. Signal line 8B may take any form as long as a deliberate delay time in the propagation of a synchronizing signal does not occur at each wireless base station 2. For example, a metal cable may be employed if domain 100 covers a relatively small communication area such as in a building or the like (the so-called micro cell or pico cell). Alternatively, an optical cable or the like may be employed if domain 100 covers a relatively large communication area. As to the mode of a synchronizing signal and the procedure for synchronization, the standard protocol for synchronization defined in IEEE (The Institute of Electrical and Electronics Engineers, Inc.) 1588 may be employed.

Furthermore, synchronizing signal generation unit 4B controls integrally the transmission power to suppress interference relative to wireless base station 2 in the corresponding domain. Specifically, synchronizing signal generation unit 4B monitors whether the accuracy of a generated synchronizing signal is below a predetermined level or not. When a determination is made that the synchronizing signal accuracy is below the predetermined level, synchronizing signal generation unit 4B obtains from each wireless base station 2 information indicating the communication state between the relevant wireless base station 2 and terminal device, and evaluates the degree of interference based on the obtained information indicating the communication state with each wireless base station 2 to generate an instruction to adjust the transmission power of each wireless base station 2.

More specifically, synchronizing signal generation unit 4B obtains through a signal line 8B from each of a plurality of wireless base stations 2 belonging to a corresponding domain the carrier to interference and noise ratio (hereinafter, also referred to as “CINR value”) and the received signal strength indicator (hereinafter, also referred to as “RSSI value”) of the terminal device in the relevant cell, as information indicating the communication state with a terminal device present in the relevant cell.

The CINR value represents the ratio of the original level of the carrier wave to carry the audio/data to be received to the level of the remaining component that becomes noise and/or interference, in the radio wave received at a certain terminal device. A larger CINR value implies that the ratio of the carrier wave in the radio wave received at the terminal device is great. Therefore, a larger CINR value implies that the interference from another wireless base station and/or another terminal device is small, whereas a smaller CINR value implies that the interference from another wireless base station and/or another terminal device is large.

The RSSI value represents the strength of a wireless signal dispatched by a terminal device, determined according to the radio wave received at the relevant terminal device. In a general multi-connection wireless communication system, the transmission power at a terminal device is adjusted according to the distance between the relevant terminal device and a corresponding wireless radio station. In other words, a terminal device remote from corresponding wireless base station 2 (located outside the cell range) transmits a wireless signal at a greater transmission power since its own transmitted wireless signal must reach wireless base station 2. Therefore, a determination can be made that a larger RSSI value implies that the terminal device is remote from the corresponding wireless base station 2 (located farther away outside the cell range).

Thus, when the accuracy of a synchronizing signal generated at a synchronizing signal generation unit 4B is below a predetermined value, the corresponding synchronizing signal generation unit 4B adjusts the cell range (transmission power) of wireless base station 2 belonging to its own domain, based on the information. Accordingly, interference with a wireless base station belonging to another domain can be suppressed. The generation accuracy of a synchronizing signal typically implies the deviation from the former synchronizing signal timing, i.e. the degree in the timing difference.

<Interference and Suppression Method Thereof>

Referring to FIGS. 12-16, interference occurring when a UPS signal cannot be received properly at synchronizing signal generation unit 4B (FIG. 11), and a method of suppression thereof will be described hereinafter.

The occurrence of interference caused by deviation in the transmission/reception timing has been already described with reference to FIG. 2. Therefore, details thereof will not be repeated.

In the case where the transmission/reception timing cannot be synchronized in wireless communication system SYS2 according to the present embodiment, synchronizing signal generation unit 4B adjusts the cell range relative to each wireless base station 2 so as to suppress occurrence of interference.

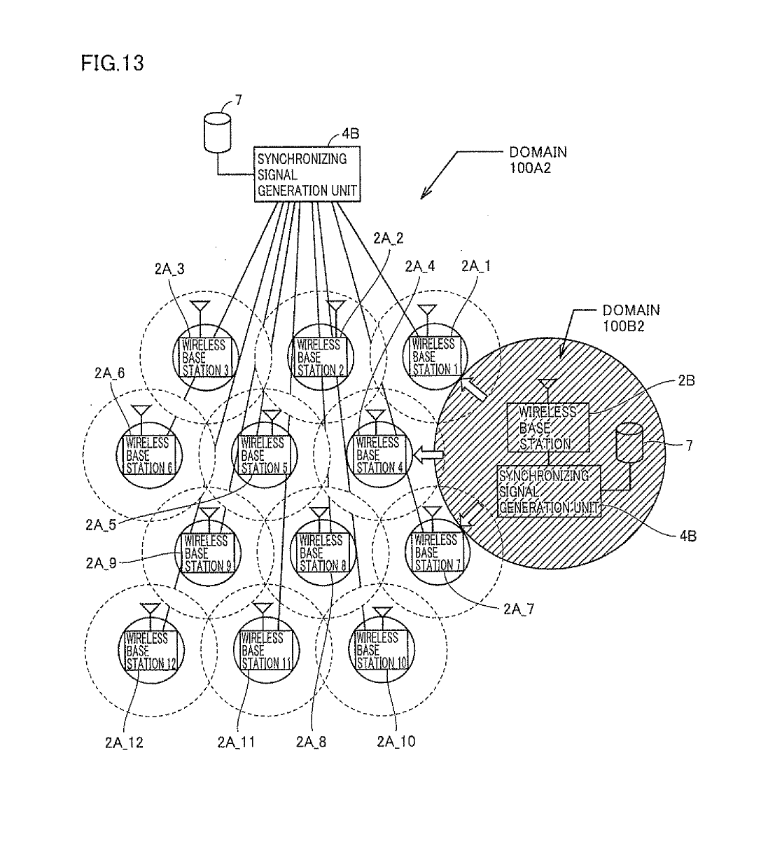

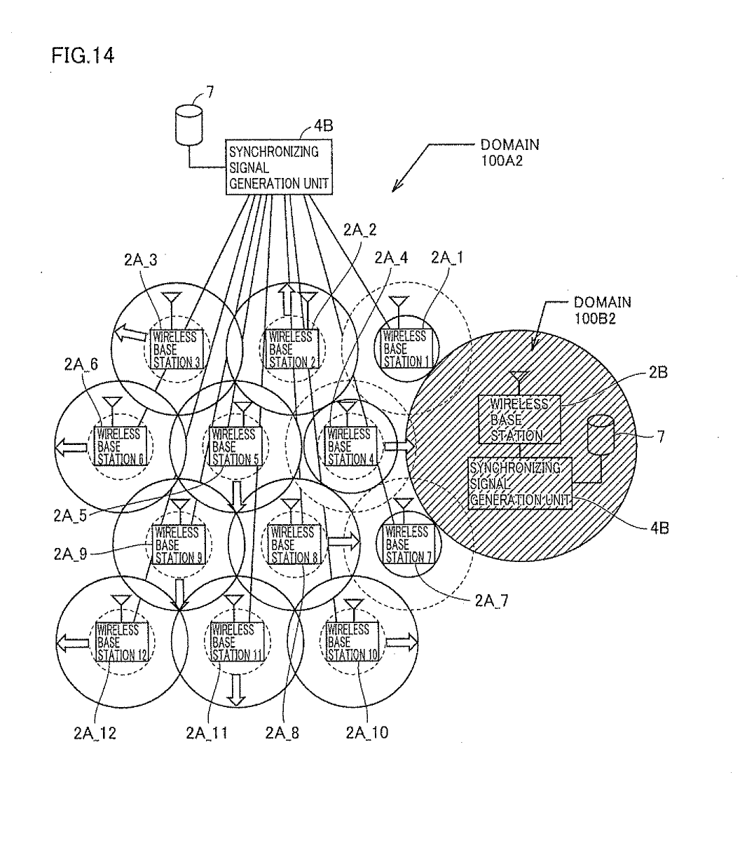

FIG. 12 represents an example of a cell arrangement of wireless communication system SYS2 according to the second embodiment. FIG. 13 represents an example of a cell arrangement immediately after the synchronizing signal accuracy falls below the predetermined level at wireless communication system SYS2 shown in FIG. 12. FIG. 14 represents an example of a cell arrangement at an elapse of a predetermined time after the synchronizing signal accuracy falls below the predetermined level at wireless communication system SYS2 shown in FIG. 12.

Wireless communication system SYS2 shown in FIG. 12 will be described by way of example. In wireless communication system SYS2 shown in FIG. 12, it is assumed that twelve wireless base stations 2A_1 to 2A_12 belong to domain 100A2, and one wireless base station 2B belongs to domain 100B2. Now, synchronizing signal generation unit 4B of domain 100A2 is disabled from properly receiving a UPS signal.

At this stage, a wireless base station adjacent to only a wireless base station belonging to the common domain 100A2 is not affected by the transmission/reception timing of domain 100B2. In view of wireless base station 2A_2, for example, four wireless base stations 2A_1, 2A_3, 2A_4 and 2A_5 are located adjacently, all belonging to domain 100A2. Therefore, even if the synchronizing signal used at domain 100A2 is deviated from the synchronizing signal used at domain 100B2, interference will not occur between wireless base stations 2A1 to 2A5.

In contrast, wireless base station 2A_1 is adjacent to two wireless base stations 2A_2 and 2A4 belonging to domain 100A2, as well as to a wireless base station 2B belonging to domain 100B2. Therefore, when if the synchronizing signal used at domain 100A2 is deviated from the synchronizing signal used at domain 100B2, interference will occur between wireless base station 2A_1 and wireless base station 28.

In such an event in wireless communication system SYS2 of the present embodiment, the cell range of wireless base station 2 of interest is further narrowed by synchronizing signal generation unit 413 providing to all wireless base stations 2 belonging to that domain an instruction to reduce or cut the transmission power. Then, synchronizing signal generation unit 4B controls a wireless base station 2 absent of interference to return the cell range thereof to the former size based on information indicating the communication state with a terminal device in each wireless base station 2.

In other words, when the accuracy of the synchronizing signal falls below a predetermined level, synchronizing signal generation unit 413 instructs a plurality of wireless base stations 2 to reduce the transmission power, and additionally instructs any wireless base station 2 that can accommodate the degree of the occurring interference to increase the transmission power.

More specifically, when the accuracy of a synchronizing signal at synchronizing signal generation unit 48 in domain 100A2 falls below the predetermined level according to the cell arrangement of wireless communication system SYS2 as shown in FIG. 12, the transmission power (cell range) of all wireless base stations 2 belonging to domain 100A2 is reduced, as shown in FIG. 13.

The amount of reducing the transmission power is preferably determined such that the reachable range of the transmission power of each wireless base station 2 does not overlap with the reachable range of transmission power of a wireless base station 2 belonging to another domain. Typically, the transmission power is preferably reduced to ¼ the former transmission power such that the radius of the cell range of each wireless base station 2 is reduced to ½ times. By setting the radius of the cell range to ½ times, the cell range of wireless base station 2 of interest can be reliably reduced to a level not overlapping with the cell range of another wireless base station 2.

Alternatively, the transmission power may be set to zero (output stopped) such that there is absolutely no interference with an adjacent wireless base station 2. Further alternatively, the transmission power subsequent to reduction may be determined in advance based on the arranged position of wireless base station 2.

After reducing the transmission power of each wireless base station 2, synchronizing signal generation unit 4B obtains information indicating the communication state (CINR value and RSSI value) from each wireless base station 2 belonging to the corresponding domain. Then, synchronizing signal generation unit 4B determines whether the cell range of each wireless base station 2 can be enlarged (restored) based on the information. In other words, synchronizing signal generation unit 4B evaluates the degree of interference based on the obtained information indicating the communication state for each wireless base station 2. Then, synchronizing signal generation unit 4B applies to a wireless base station 2 determined that the cell range can be enlarged an instruction to restore the transmission power to the former level.

By this instruction, the cell range of domain 100A2 as shown in FIG. 13, for example, is modified to the cell range as shown in FIG. 14. Specifically, for wireless base stations 2A_2, 2A_3, 2A_5, 2A_6, and 2A_8 to 2A_12 adjacent to only the wireless base station belonging to the same domain 100A2, the cell range is restored to its former size. For wireless base station 2A_4, the cell range is restored to a level that does not overlap with the cell range of wireless base station 2B belonging to adjacent domain 100B2. In contrast, wireless base stations 2A_1 and 2A_7 have their cells range maintained at the reduced size.

Furthermore, the cell range can be further reduced when a determination is made that interference still occurs despite the cell range being reduced, as will be described afterwards.

By adjusting the cell range of each wireless base station 2, interference with a terminal device located at a different domain can be reduced. Such a process allows the area where the conversation and/or communication service is stopped to be minimized even in the case where a GPS signal cannot be received properly, i.e. when the accuracy of the synchronizing signal generated by synchronizing signal generation unit 4B cannot be ensured.

The process of evaluating the degree of interference based on the information (CINR value and RSSI value) indicating the communication state at each wireless base station 2 will be described hereinafter.

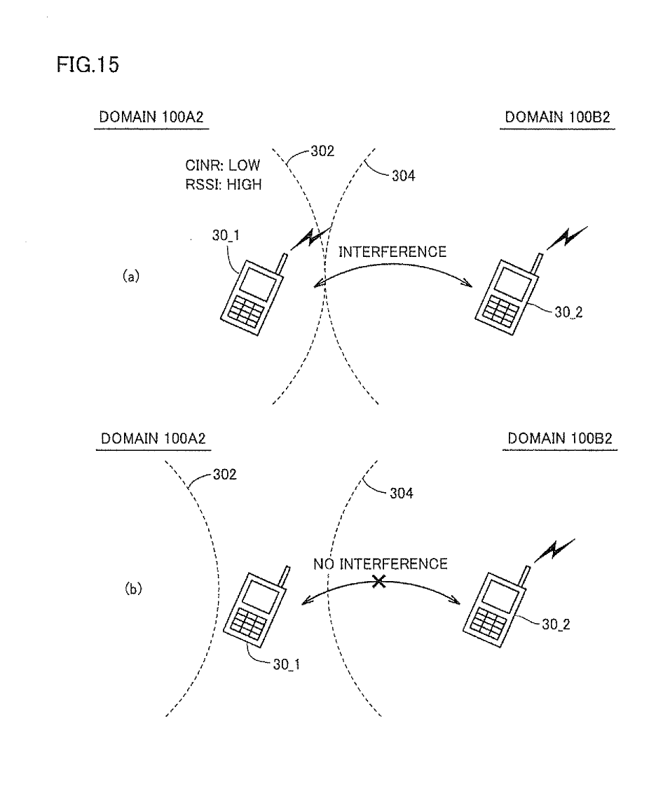

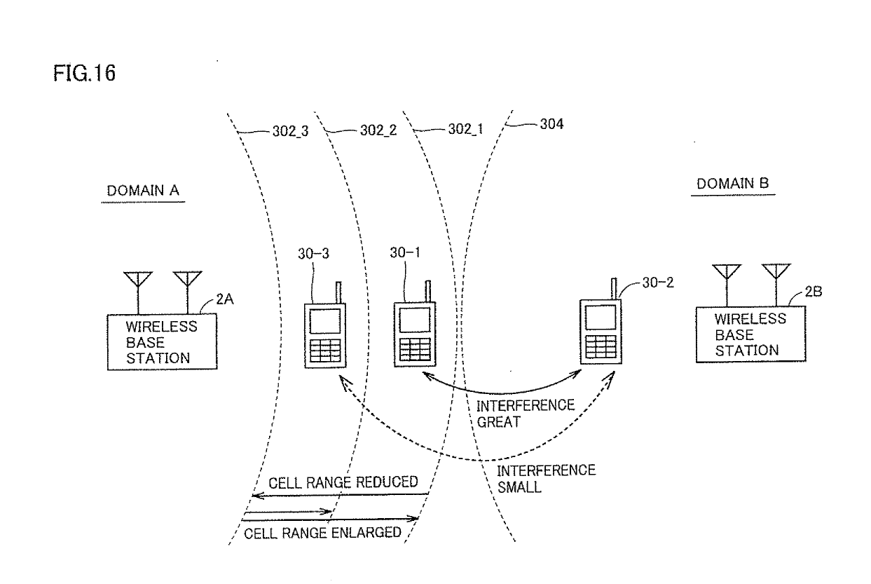

FIGS. 15 and 16 are diagrams to describe the transmission power adjustment processing at wireless communication system SYS2 according to the second embodiment.

By way of example, consider the case of a terminal device located in the proximity of the border of the cell range of a wireless base station 2 belonging to a different domain. As shown in FIG. 15 (a), for example, it is assumed that there is a terminal device 30_1 in a cell range 302 of wireless base station 2 belonging to domain 100A2, and there is a terminal device 30_2 in a cell range 304 of a wireless base station 2 belonging to domain 100B2. It is assumed that the synchronizing signal utilized in domain 100A2 and domain 100B2 is generated with deviation in timing.

For terminal device 30_1, terminal device 30_2 located in cell range 304 becomes the interference cause (noise source). Specifically, since the reception period of terminal device 30_1 and the transmission period of terminal device 30_2 overlap by deviation in timing of the synchronizing signal, a wireless signal issued from terminal device 30_2 will be received as an interference signal (noise signal) of terminal device 30_1. Therefore, the CINR value of terminal device 30_1 shows a lower value.

Furthermore, since terminal device 30_1 is located at a site close to the cell edge of cell range 302, the wireless signal received from a corresponding wireless base station 2 is weak. Therefore, the RSSI value of terminal device 30_1 shows a higher value.

Thus, synchronizing signal generation unit 4B determines that, according to the CINR value and the RSSI value obtained from each terminal device belonging to the cell range of each wireless base station 2, intolerable interference is occurring at a terminal device located in the cell range of the relevant wireless base station 2 if the CINR value and the RSSI value are smaller than a predetermined threshold value THCINR and larger than a predetermined threshold value THRSSI, respectively.

Therefore, as shown in FIG. 15 (b), synchronizing signal generation unit 4B maintains the size of cell range 302 for a wireless base station 2 having interference occurring in its cell to a level that does not cause interference with a cell range belonging to domain 100B2.

When the accuracy of the synchronizing signal at any synchronizing signal generation unit 4B falls below a predetermined level according to wireless communication system SYS2 of the present embodiment, the cell range of wireless base station 2 belonging to the corresponding domain is temporarily reduced. Then, any wireless base station 2 absent of interference with a wireless base station belonging to another domain has its cell range enlarged (restored).

Specifically, when the accuracy of the generated synchronizing signal falls below a predetermined level, the former cell range 302_1 is reduced to cell range 302_3, as shown in FIG. 16. Then, according to the state of the terminal device located within that cell range, cell range 302_3 is enlarged to cell range 302_1 or cell range 302_2.

For example, in the case where intolerable interference occurs between terminal device 30_1 in cell range 302_1 of wireless base station 2 belonging to domain 100A2 and terminal device 30_2 in cell range 304 of wireless base station 2 belonging to domain 100B2, the transmission power of wireless base station 2 belonging to domain 100A2 cannot be increased up to a level corresponding to cell range 302_1. In other words, when the CINR value of terminal device 301 is smaller than threshold value THRCINR and the RSSI value of terminal device 30_1 is larger than predetermined threshold value THRSSI, enlargement of the cell range is cancelled.

In contrast, in the case where the interference occurring between terminal device 30_3 in cell range 302_2 of wireless base station 2 belonging to domain 100A2 and terminal device 30_2 in cell range 304 of wireless base station 2 belonging to domain 100B2 is tolerable, the transmission power of wireless base station 2 belonging to domain 100A2 is increased up to a level corresponding to cell range 302_2. Specifically, in the case where the CINR value of terminal device 30_1 is larger than threshold value THRCINR and the RSSI value of terminal device 30_1 is smaller than predetermined threshold value THRSSI, the cell range is enlarged so as to be restored to the former size to the best possible degree.

<Configuration of Wireless Base Station>

A configuration of wireless base station 2 according to the present embodiment will be described hereinafter.

The hardware configuration of wireless base station 2 according to the second embodiment has been described already with reference to FIG. 5. Therefore, detailed description thereof will not be repeated.

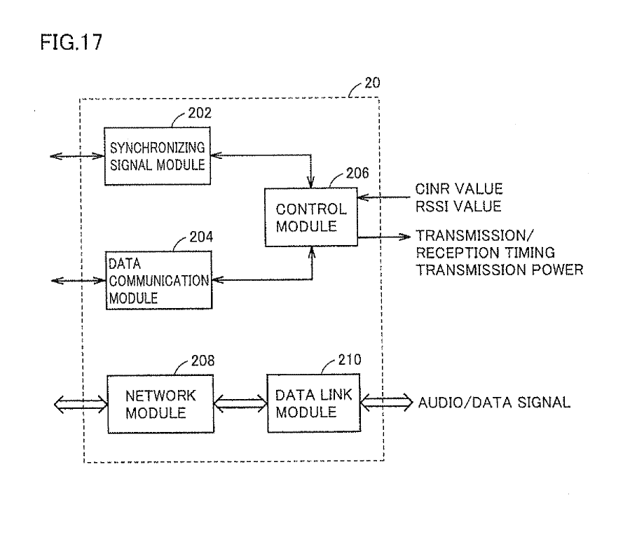

FIG. 17 represents an example of a processing structure of a control unit 20 in a wireless base station according to the second embodiment.

Referring to FIG. 17, control unit 20 includes, as the processing structure, a synchronizing signal module 202, a data communication module 204, a control module 206, a network module 208, and a data link module 210.

Synchronizing signal module 202 applies an internal instruction to control module 206 based on the synchronizing signal from synchronizing signal generation unit 4B received via synchronizing signal I/F 29.

Data communication module 204 responds to an internal instruction from control module 206 to transmit, via synchronizing signal I/F 29, information such as the CINR value and RSSI value to synchronizing signal generation unit 4B.

Control module 206 applies the transmission/reception timing to coding/decoding circuit 24 (FIG. 5) based on an internal instruction from synchronizing signal module 202. Namely, synchronizing signal module 202 and control module 206 adjust the transmission/reception timing with a terminal device according to the synchronizing signal.

Control module 206 adjusts the transmission power according to an instruction from synchronizing signal generation unit 4B that will be described afterwards. Specifically, when the accuracy of the synchronizing signal generated at its own connected synchronizing signal generation unit 4B falls below a predetermined level, an instruction is transmitted from synchronizing signal generation unit 4B. In response, control module 206 notifies reduction or cutting of the transmission power (modifying the transmission strength) so as to narrow the cell range of its own station.

Control module 206 outputs to data communication module 204 information indicating the communication state with a terminal device, including the CINR value and RSSI value calculated at coding/decoding circuit 24 (FIG. 5).

Network module 208 assumes the network layer function of the so-called OSI model. In other words, network module 208 performs routing and the like of audio/data transferred between the exchanger and a terminal device.

Data link module 210 assumes the data link layer function of the so-called OSI model. In other words, data link module 210 controls the delivery of a signal between a wireless base station 2 (FIG. 11) and a terminal device.

<Configuration of Synchronizing Signal Generation Unit>

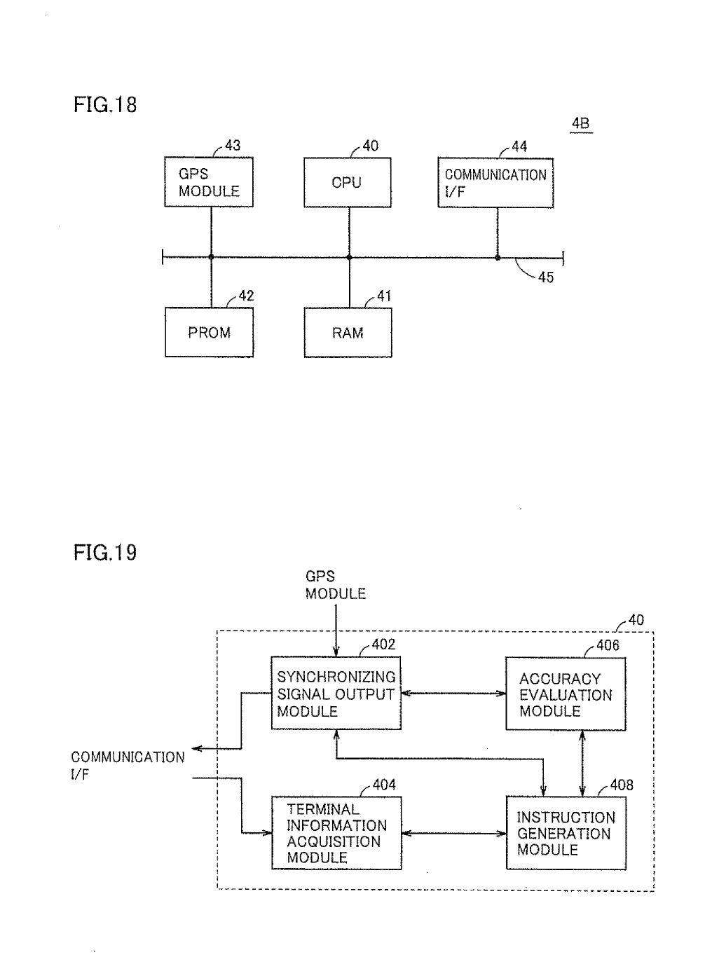

A configuration of synchronizing signal generation unit 4B according to the present embodiment will be described with reference to FIGS. 18 and 19.

FIG. 18 shows an example of a hardware configuration of synchronizing signal generation unit 413 according to the second embodiment. FIG. 19 shows an example of a processing structure provided by CPU 40 of FIG. 18.

Referring to FIG. 18, synchronizing signal generation unit 4B according to the present embodiment includes a CPU 40, a RAM 41, a PROM (Programmable Read Only Memory) 42, a GPS module 43, and a communication interface (hereinafter, referred to as “communication I/F”) 44. Each of these elements is configured to allow data communication with each other via an internal bus 45.

CPU 40 that is an operation device transfers a program code prestored in PROM 42 to RAM 41 to execute various processing according to the relevant program code. RAM 41 stores, in addition to the program code executed by CPU 40, various work data required for the execution of a program code.

Data communication I/F 44 provides the access from each wireless base station 2.

GPS module 43 generates a synchronizing signal based on a GPS signal received from a GPS satellite. It is assumed that GPS module 43 according to the present embodiment can generate a synchronizing signal, even if reception of a GPS signal is interrupted, having an accuracy of a level identical to a synchronizing signal based on a GPS signal for a predetermined period of time. Such a function is called a “hold over” function. For example, synchronizing signal generation unit 413 can continuously generate a synchronizing signal for approximately 24 hours even if a GPS signal cannot be received.

Although a GPS module having such a hold over function is relatively costly, a configuration in which one synchronizing signal generation unit 4B is shared among a plurality of wireless base stations 2, as in wireless communication system SYS2 of the present embodiment, allows a GPS module with a hold over function, having high accuracy and reliability, to be employed, while suppressing the cost of the entire system. GPS module 43 of the present embodiment outputs the information indicating the generation accuracy of a synchronizing signal (currently receiving GPS properly, in a hold over state, out of hold over state) included in a synchronizing signal.

However, synchronizing signal generation unit 4B will not be able to generate a synchronizing signal having a timing identical to that of synchronizing signal generation unit 4B of another domain unless a GPS signal is received within a predetermined period of time, even if such a hold over function is provided.

It is to be noted that a GPS module 43 without such a hold over function may be employed.

Referring to FIG. 19, CPU 40 provides, as a control structure, a synchronizing signal output module 402, a terminal information acquisition module 404, an accuracy evaluation module 406, and an instruction generation module 408.

Synchronizing signal output module 402 transmits a synchronizing signal output from GPS module 43 (FIG. 10) to each connected wireless base station 2 via communication I/F 44 (FIG. 10). Synchronizing signal output module 402 adds an instruction to adjust the transmission power of each wireless base station 2 to the synchronizing signal, received from instruction generation module 408 that will be described afterwards.

In the case where the information flowing through signal line 8B is a broadcast message, i.e. not a communication scheme in which data is transmitted to only a certain wireless base station 2, synchronizing signal output module 402 adds identification information or the like of a wireless base station to be transmitted to the instruction from instruction generation module 408 that will be described afterwards for transmission. Accordingly, each wireless base station 2 may selectively receive only an instruction having its own station identification number added.

Synchronizing signal output module 402 outputs the synchronizing signal received from GPS module 43 to accuracy evaluation module 406.

Terminal information acquisition module 404 responds to an internal instruction from instruction generation module 408 to obtain from each connected wireless base station 2 information (CINR value and RSSI value) indicating the communication state for a terminal device conducting wireless communication with the relevant wireless base station 2. Such information is transmitted from each wireless base station 2 via signal line 8B. An exclusive line for transmitting information indicating such a communication state may be additionally provided. Specifically, terminal information acquisition module 404 is comparable to means for obtaining, from each of a plurality of wireless base stations 2, information indicating the communication state between the relevant wireless base station 2 and a terminal device.

Accuracy evaluation module 406 determines whether the accuracy of the synchronizing signal applied to wireless base station 2 of the connection party maintains a predetermined level or not. Typically, accuracy evaluation module 406 determines the accuracy of the synchronizing signal based on the reception state of the GPS signal at GPS module 43 (currently receiving GPS properly, in a hold over state, in an out of hold over state). When a determination is made that the accuracy of the synchronizing signal is below the predetermined level, accuracy evaluation module 406 applies the evaluation result to instruction generation module 408. Specifically, accuracy evaluation module 406 is comparable to means for determining whether the accuracy of a synchronizing signal generated at GPS module 43 is below a predetermined level or not.

Furthermore, accuracy evaluation module 406 also determines whether the accuracy of a synchronizing signal generated at GPS module 43, subsequent to falling below a predetermined level, has recovered to a predetermined level. When a determination is made that the accuracy of the synchronizing signal has recovered to the predetermined level, accuracy evaluation module 406 applies the evaluation result to instruction generation module 408. Namely, accuracy evaluation module 406 determines whether reception of a GPS signal has been resumed or not when GPS module 43 is in an out of hold over state.

Even in the case where a GAS signal is received properly, there is a possibility of the generation accuracy of the synchronizing signal being degraded due to some cause. Therefore, the generation accuracy of a synchronizing signal may be evaluated based on variation (dispersion) of the amount of jittering in the synchronizing signal generated at GPS module 43.

Instruction generation module 408 generates to each connected wireless base station 2 an instruction to adjust the transmission power. More specifically, when the accuracy of a synchronizing signal generated at GPS module 43 falls below a predetermined value, instruction generation module 408 generates and sends all together an instruction to reduce the transmission power at each of wireless base stations 2. Then, instruction generation module 408 generates for each wireless base station 2 an instruction about the transmission power such that a cell range as large as possible, absent of interference, can be provided, based on information (CINR value and RSSI value) indicating the transmission state for a terminal device from terminal information acquisition module 404. Namely, synchronizing signal output module 402 is comparable to means for generating an instruction directed to adjusting the transmission power of each wireless base station 2 by evaluating the level of interference based on the obtained information indicating the communication state for each wireless base station 2.

When the accuracy of the generated synchronizing signal recovers to the former level subsequent to falling below the predetermined level at GPS module 43, instruction generation module 408 generates and sends all together an instruction to restore the transmission power of each wireless base station 2 to the former level. Specifically, instruction generation module 408 is comparable to means for generating an instruction, when the accuracy of the synchronizing signal recovers to the predetermined level, to restore the power transmission of wireless base station 2 instructed to have its transmission power reduced, among the wireless base stations connected to synchronizing signal generation unit 4B whose accuracy of the synchronizing signal has recovered to the predetermined level.

<Processing Procedure>

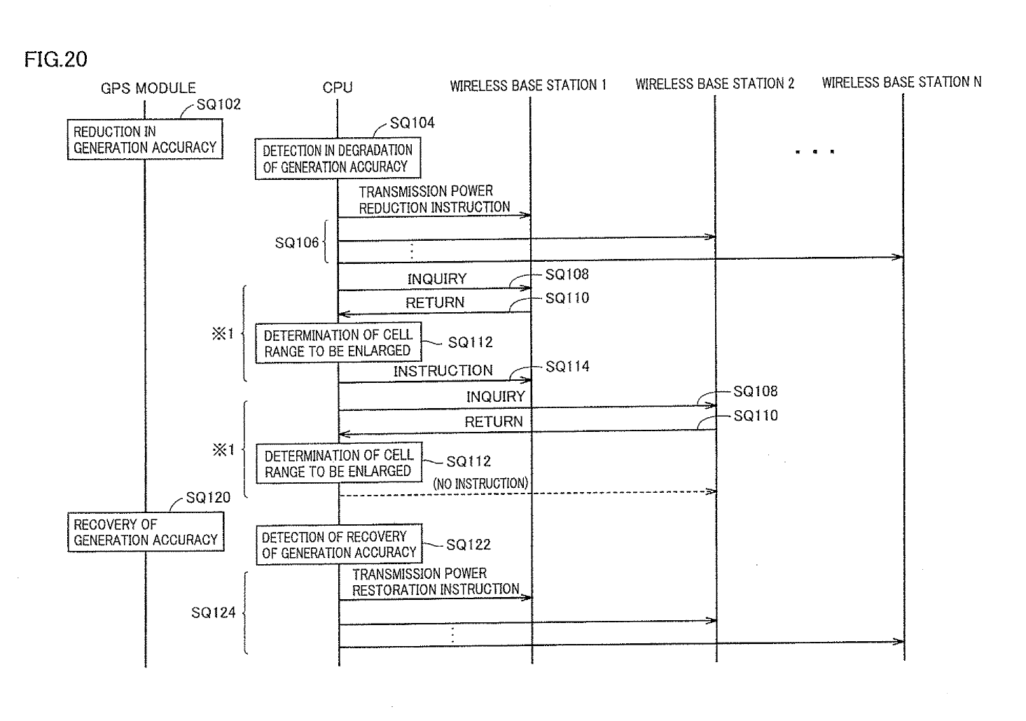

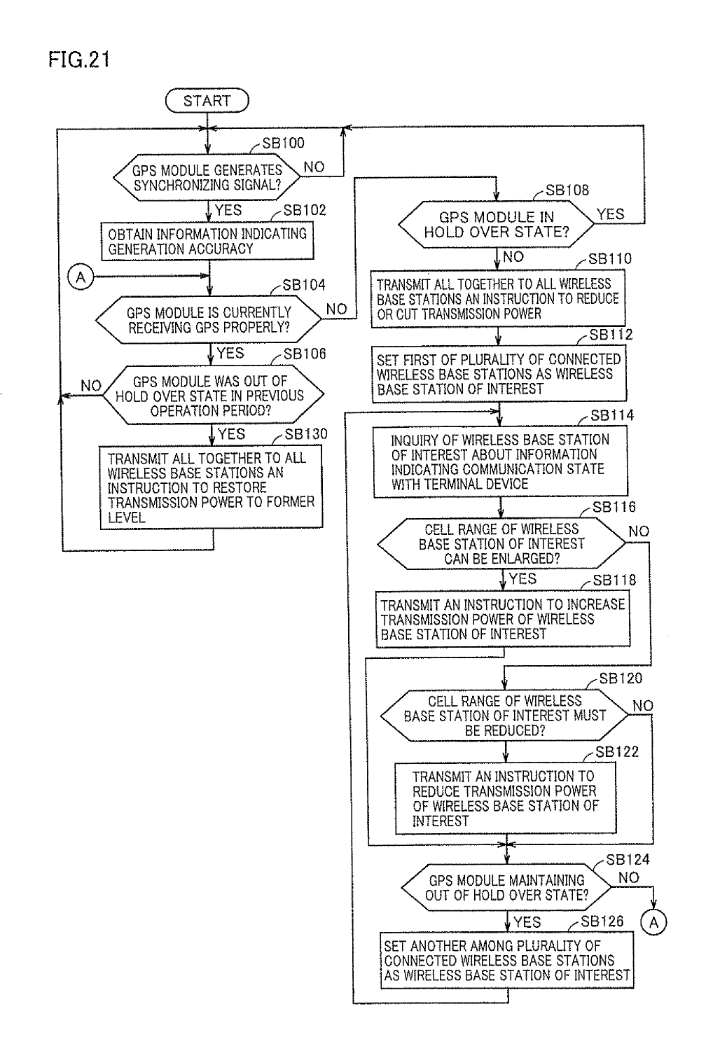

The processing procedure of the present embodiment will be described hereinafter with reference to FIGS. 20 and 21.

FIG. 20 represents the sequence of the process at each element in wireless communication system SYS2 according to the second embodiment. FIG. 21 is a flowchart of an operation at synchronizing signal generation unit 4B according to the second embodiment.

(1. Overall Sequence)

Referring to FIG. 20, it is assumed that the generation accuracy of the synchronizing signal at GPS module 43 of synchronizing signal generation unit 4B is degraded by some cause (sequence SQ102). CPU 40 of synchronizing signal generation unit 4B detects reduction in the generation accuracy of the synchronizing signal (sequence SQ104). In response, CPU 40 sends an instruction designating reduction of the transmission power all together to the connected wireless base stations in order to suppress the occurrence of interference with an adjacent wireless base station (sequence SQ106). Then, CPU 40 repeatedly executes the process for adjusting the transmission power of each wireless base station.

Specifically, CPU 40 inquires of one of the connected wireless base stations about the information (CINR value and RSSI value) indicating the communication state with a terminal device located in the cell range (sequence SQ108). Upon receiving a response from the inquired wireless base station (sequence SQ110), CPU 40 determines whether the cell range of the relevant wireless base station can be enlarged or not (sequence SQ112). In other words, CPU 40 evaluates the degree of interference based on the obtained information indicating the communication state with each wireless base station 2. Specifically, CPU 40 determines that the cell range of the wireless base station of interest can be enlarged when the received CINR value is greater than predetermined threshold value THCINR and the RSSI value is smaller than predetermined threshold value THRSSI. In contrast, CPU 40 determines that the cell range of the wireless base station of interest must be further reduced when the received CINR value is smaller than predetermined threshold value THCINR and the RSSI value is greater than predetermined threshold value THRSSI.

Based on the determination result, CPU 40 transmits an instruction for designating the level of the transmission power for the wireless base station of interest (sequence SQ114).

It is to be noted that CPU 40 does not transmit a further instruction in the case where neither of the conditions match. Accordingly, the size of a cell range for the wireless base station of interest will be maintained.

The process of sequence SQ108-SQ114 is repeatedly executed for each wireless base station (*1 process in FIG. 20).

Then, it is assumed that the generation accuracy of the synchronizing signal at GPS module 43 has been recovered (sequence SQ120). Upon detecting recovery of the generation accuracy of the synchronizing signal (sequence SQ122), CPU 40 sends all together an instruction designating restoration of the transmission power (sequence SQ124). Thus, wireless communication system SYS2 can provide the normal communication area.

(2. Operation Flow)

The operation flow at synchronizing signal generation unit 4B will be described hereinafter.

Referring to FIG. 21, CPU 40 (FIG. 18) of synchronizing signal generation unit 4B determines whether UPS module 43 (FIG. 10) has generated a synchronizing signal or not (step SB100). If a synchronizing signal is not generated (NO at step SB100), the process at step SB100 is repeated.

If a synchronizing signal is generated (YES at step SB100), CPU 40 obtains information indicating the generation accuracy of the synchronizing signal included in the generated synchronizing signal (step SB102). Then, CPU 40 determines whether GPS module 43 is currently receiving GPS properly (step SB104). Namely, CPU 40 determines whether the accuracy of the synchronizing signal generated at GPS module 43 is below a predetermined level.

When GPS module 43 is currently receiving GPS properly (YES at step SB104), CPU 40 determines whether GPS module 43 was in an out of hold over state in the previous operation period (step SB106). Namely, CPU 40 determines whether the accuracy of the synchronizing signal generated at GPS module 43 has recovered to the predetermined level subsequent to falling below the predetermined level. In other words, CPU 40 determines whether reception of a GPS signal has been resumed or not when GPS module 43 is in an out of hold over state.

In the case where GPS module 43 was in an out of hold over state in the previous operation period (YES at step SB106), control proceeds to step SB130. When GPS module 43 was not in an out of hold over state in the previous operation period (NO at step SB106), the subsequent processing is skipped, and the processing of steps SB 100 and et seq. is repeated.

In contrast, when GPS module 43 is not currently receiving GPS properly (NO at step SB104), CPU 40 determines whether GPS module 43 is in a hold over state (step SB108). If GPS module 43 is in a hold over state (YES at step SB108), the subsequent processing is skipped, and the processing of steps SB 100 and et seq. is repeated.

If GPS module 43 is not in a hold over state (NO at step SB108), i.e., GPS module 43 is in an out of hold over state, CPU 40 executes the transmission power adjustment process set forth below.

First, CPU 40 sends all together an instruction to reduce or cut the transmission power to all wireless base stations 2 connected to synchronizing signal generation unit 4B (step SB110). Accordingly, the cell range of all wireless base stations 2 connected to GPS module 43 in a hold over state is temporarily reduced.

CPU 40 sets the first among a plurality of connected wireless base stations as the wireless base station of interest (step SB112). Then, CPU 40 inquires of the wireless base station of interest about information (CINR value and RSSI value) indicating the communication state with a terminal device located in the cell range (step SB114). Namely, when the accuracy of the synchronizing signal is below a predetermined level, CPU 40 obtains from each of the plurality of wireless base stations 2 information indicating the communication state between the relevant wireless base station 2 and a terminal device.

Then, by evaluating the degree of interference based on the obtained information indicating the communication state of each wireless base station 2 as shown in steps SB116-SB122, CPU 40 executes the process of generating an instruction to adjust the transmission power of each wireless base station 2.

First, CPU 40 determines whether the cell range of the wireless base station of interest can be enlarged or not (step SB116). Specifically, CPU 40 determines whether the CINR value and RSSI value received from wireless base station 2 of interest are larger than predetermined threshold value THCINR and smaller than predetermined threshold value THRSSI, respectively. This process is directed to determining whether the degree of interference occurring at wireless base station 2 of interest is tolerable or not.

When a determination is made that the cell range of the wireless base station of interest can be enlarged (YES at step SB116), CPU 40 generates an instruction to increase the current transmission power for the wireless base station of interest, and transmits the generated instruction to the wireless base station of interest (step SB118). Then, control proceeds to step SB124.

When a determination is made that the cell range of the wireless base station of interest cannot be enlarged (NO at step SB116), CPU 40 determines whether the cell range of the wireless base station of interest must be reduced or not (step SB120). Specifically, CPU 40 determines whether the CINR value and RSSI value received from the wireless base station of interest are smaller than predetermined threshold value THCINR and larger than predetermined threshold value THRSSI, respectively. This process is directed to determining whether the degree of interference occurring at wireless base station 2 of interest is intolerable.

When a determination is made that the cell range of the wireless base station of interest must be reduced (YES at step SB120), CPU 40 generates an instruction to reduce the current transmission power for the wireless base station of interest, and transmits the generated instruction to the wireless base station of interest (step SB122). Then, control proceeds to step SB124.

When a determination is made that the cell range of the wireless base station of interest does not have to be reduced (NO at step SB120), no instruction is generated, and control proceeds to step SB124.

At step SB124, CPU 40 determines whether GPS module 43 is maintaining the out of hold over state (step SB124). When GPS module 43 is continuing the out of hold over state (YES at step SB124), CPU 40 sets another of the plurality of connected wireless base stations as the wireless base station of interest (step SB126). Then, the processing of steps SB 114 and et seq. is repeated.

When GPS module 43 is not continuing the out of hold over state (NO at step SB 124), control returns to step SB104.

At step SB130, CPU 40 sends all together an instruction to restore the transmission power to the former level to all wireless base stations 2 connected to synchronizing signal generation unit 4B (step SB130). Accordingly, the cell range of all wireless base stations 2 is restored to the former state in association with the recovery of the accuracy of synchronizing signal at GPS module 43.

[Modification]

The above-described embodiment is based on an example of a synchronizing signal generation unit including the function of generating a synchronizing signal and the function of controlling the transmission power of each wireless base station. These functions may be separated. In this case, the main unit having the function of generating a synchronizing signal may integrally adjust the transmission power of wireless base station 2 belonging to each of a plurality of domains.

The above-described embodiment is based on an example of a configuration in which the cell range of wireless base stations belonging to a certain domain are all reduced together, and then the cell range of each wireless base station 2 is progressively adjusted according to the occurring status of interference. Instead of reducing the cell range of all wireless base stations at one time, the transmission power of a wireless base station belonging to a domain of interest may be adjusted concurrently.

The above-described embodiment is based on an example of a configuration evaluating the degree of interference at each wireless base station based on a carrier to interference and noise ratio (CINR value) and received signal strength (RSSI value). The degree of interference may be evaluated using only one of these items of information. Furthermore, in addition to or alternative to these items of information, another item of information representing the communication status with a terminal device for each wireless base station 2 may be employed. Such an example of another item of information includes the number of generated errors, the number of retransmission, the communication rate, the number of generated collisions, and the like.

Since the wireless communication system of the present embodiment shares a synchronizing signal generation unit generating a synchronizing signal among a plurality of wireless base stations, a GPS module of higher accuracy and reliability can be employed while suppressing the cost of the entire system.

Furthermore, the wireless communication system of the present embodiment allows the transmission power to be adjusted to suppress interference with respect to a wireless base station connected to another synchronizing signal generation unit even in the case where a signal from a satellite including time information (for example, GPS signal) cannot be received at the synchronizing signal generation unit due to some cause and the accuracy of the generated synchronizing signal cannot be maintained. As a result, the conversation and/or communication service can be continued to the best possible degree even in the case where the accuracy of the synchronizing signal is not ensured.

Furthermore, the wireless communication system of the present embodiment allows the cell range to be adjusted dynamically without having to take into account the geometry (position relationship) and/or transmission strength state of a wireless base station belonging to another domain. Therefore, the service range can be maintained efficiently while suppressing occurrence of interference.

<Other Format>

According to the present embodiment, there is provided a control method of a wireless communication system providing conversation/communication by a terminal device. The control method includes the steps of: a synchronizing signal generation unit generating a synchronizing signal based on a signal from a satellite including time information; each of a plurality of wireless base stations adjusting according to a synchronizing signal from a synchronizing signal generation unit the transmission/reception timing with a terminal device; a control unit determining whether the accuracy of a synchronizing signal generated at the synchronizing signal generation unit is below a predetermined level; the control unit obtaining, when the accuracy of the synchronizing signal is below a predetermined level, information indicating the communication state between the relevant wireless base station and a terminal device from each of a plurality of wireless base stations; and the control unit evaluating the degree of interference based on the obtained information indicating the communication state for each wireless base station to generate an instruction to adjust the transmission power of each wireless base station.

According to the present embodiment, there is provided a control device constituting a wireless communication system including a plurality of wireless base stations to provide conversation/communication by a terminal device. Each of the plurality of wireless base stations is connected to a synchronizing signal generation unit generating a synchronizing signal based on a signal from a satellite including time information, and is configured to adjust the transmission/reception timing with a terminal device according to a synchronizing signal. The control device determines whether the accuracy of the synchronizing signal generated at the synchronizing signal generation unit is below a predetermined level or not, and when the accuracy of the synchronizing signal is below the predetermined level, obtains, from each of a plurality of wireless base stations, information indicating the communication state between the relevant wireless base station and a terminal device, and evaluates the degree of interference based on the obtained information indicating the communication state with each wireless base station to generate an instruction to adjust the transmission power of each wireless base station.

### Third Embodiment

<System Configuration>

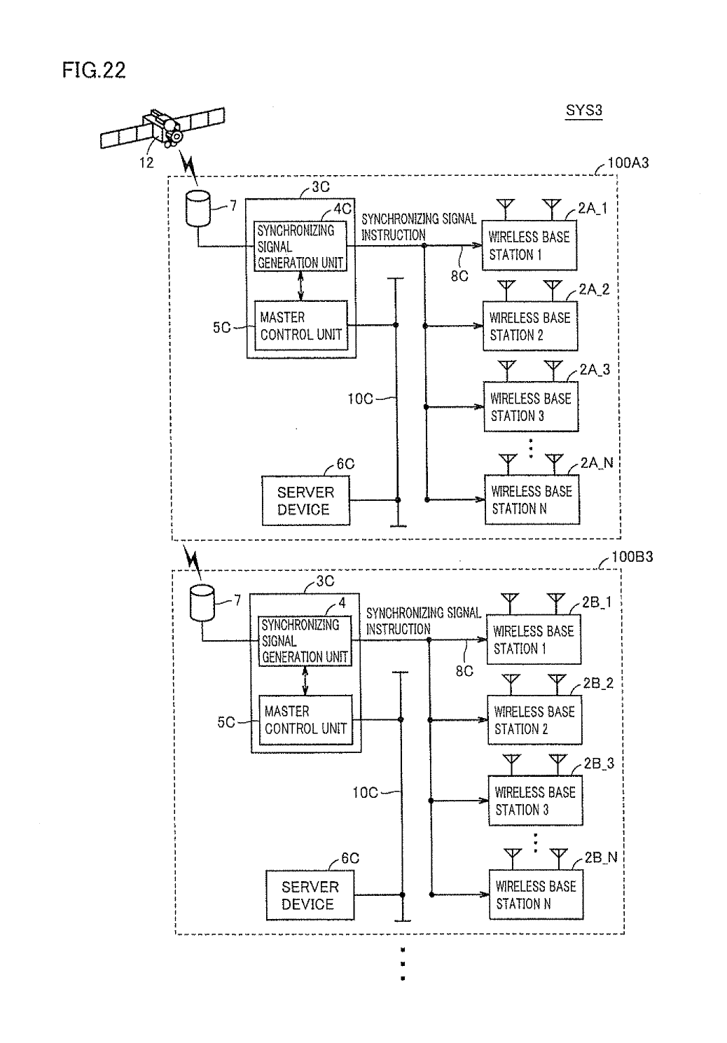

FIG. 22 is a schematic view of a configuration of a wireless communication system SYS3 according to a third embodiment. Referring to FIG. 22, wireless communication system SYS3 includes a plurality of domains 100A3, 1003B (hereinafter, also generically referred to as “domain 100”). Domain 100 is a group of wireless base stations controlling the transmission/reception timing according to a common synchronizing signal. Specifically, each domain 100 includes a plurality of wireless base stations 2, a control device 3C, and a server device 6C.

Each wireless base station shown in FIG. 22 is assigned a reference numeral of “2A_1”, “2A_2”, . . . based on a combination of the domain to which it belongs and its identification information in the relevant domain.

Although not shown in FIG. 22, each wireless base station 2 is connected to an exchanger to transfer the audio/data received from a terminal device to the exchanger, or transferring the audio/data received from the exchanger to a designated terminal device.

Control device 3C controls together wireless base stations 2 in a corresponding domain. Specifically, control device 3C includes a synchronizing signal generation unit 4C, and a master control unit 5C.

At this stage, each wireless base station 2 is connected to one of a plurality of control devices 3C to control the transmission and reception timing of a wireless signal with a terminal device according to the synchronizing signal from synchronizing signal generation unit 4C in the connected control device 3C. Accordingly, interference (crosstalk) caused by deviation in the transmission/reception timing of wireless signals can be reduced at least in the cell covered by wireless base station 2 belonging to the same domain 100. A “cell” is substantially comparable to the reachable range of transmission power from a corresponding wireless base station 2.

Synchronizing Signal Generation Unit 4C generates a synchronizing signal based on a signal from a satellite including time information. Typically, synchronizing signal generation unit 4C uses a GPS signal as the signal from a satellite including time information. Specifically, synchronizing signal generation unit 4C includes a GPS module to receive a GPS signal from a GPS satellite 12 via an antenna 7. Synchronizing signal generation unit 4C generates a synchronizing signal that is a timing signal based on the contents (time information) of the received GPS signal. In every domain 100, each wireless base station 2 is connected to allow communication with synchronizing signal generation unit 4C in control device 3C via a signal line 8C. Synchronizing signal generation unit 4C presents a synchronizing signal to each wireless base station 2 via signal line 8C. Signal line 8C may take any form as long as a deliberate delay time in the propagation of a synchronizing signal does not occur at each wireless base station 2. For example, a metal cable may be employed if domain 100 covers a relatively small communication area such as in a building or the like (the so-called micro cell or pico cell). Alternatively, an optical cable or the like may be employed if domain 100 covers a relatively large communication area. As to the mode of a synchronizing signal and the procedure for synchronization, the standard protocol for synchronization defined in IEEE (The Institute of Electrical and Electronics Engineers, Inc.) 1588 may be employed.

Master control unit 5C executes integrally the control for suppressing interference relative to wireless base station 2 in a corresponding domain. Specifically, master control unit 5C is connected in an accessible manner to server device 6C via a data line 10C. Server device 6C is comparable to a management unit managing information associated with the arranged position of a plurality of wireless base stations 2. Specifically, server device 6C holds a domain list (information of the domain to which each wireless base station 2 belongs) and a neighbor list (information of an adjacent station), as will be described afterwards. Although any type may be employed for data line 10C, typically a data communication system such as the Ethernet (registered trademark) can be employed.

When the accuracy of the synchronizing signal generated at a corresponding synchronizing signal generation unit 4C falls below a predetermined level, master control unit 5C obtains the required information from server device 6C, and applies to wireless base station 2 in the corresponding domain an instruction to suppress interference, as will be described afterwards. Master control unit 5C is comparable to a control unit controlling the transmission power of wireless base station 2.

Synchronizing signal generation unit 4C outputs, in addition to the synchronizing signal, information indicating the generation accuracy of a synchronizing signal according to the reception state. The generation accuracy of a synchronizing signal typically implies the deviation from the former synchronizing timing, i.e. the degree in timing difference.

FIG. 22 shows an example of a configuration in which a server device 6C is arranged for each domain. A configuration in which a common server device 6C is shared among a plurality of domains may be employed. Alternatively, in the case where server device 6C is arranged for each domain, server device 6C may be integrated into control device 3C for every domain to be provided as one main unit.

<Interference and Suppression Method Thereof>

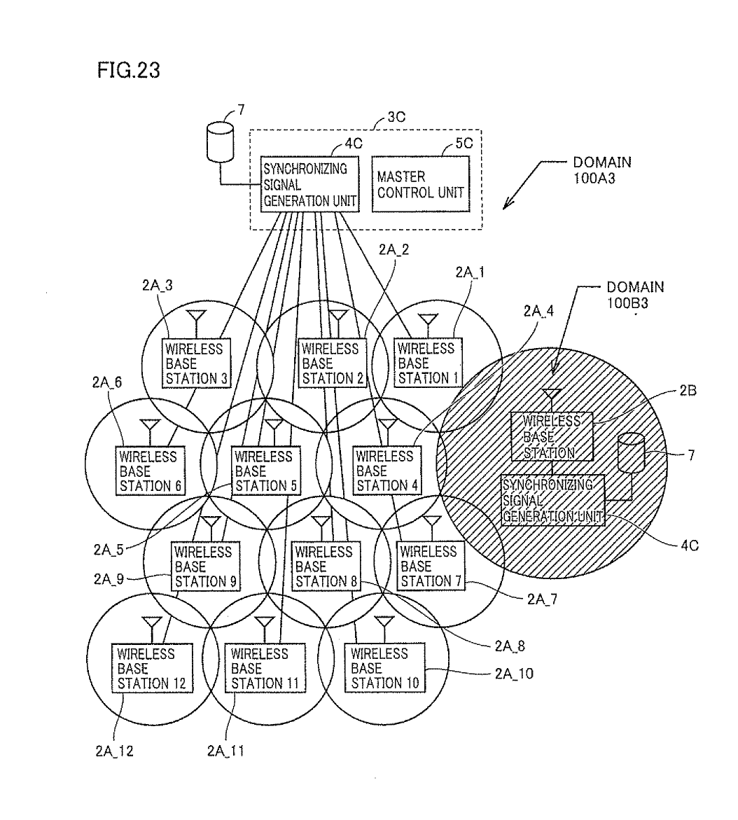

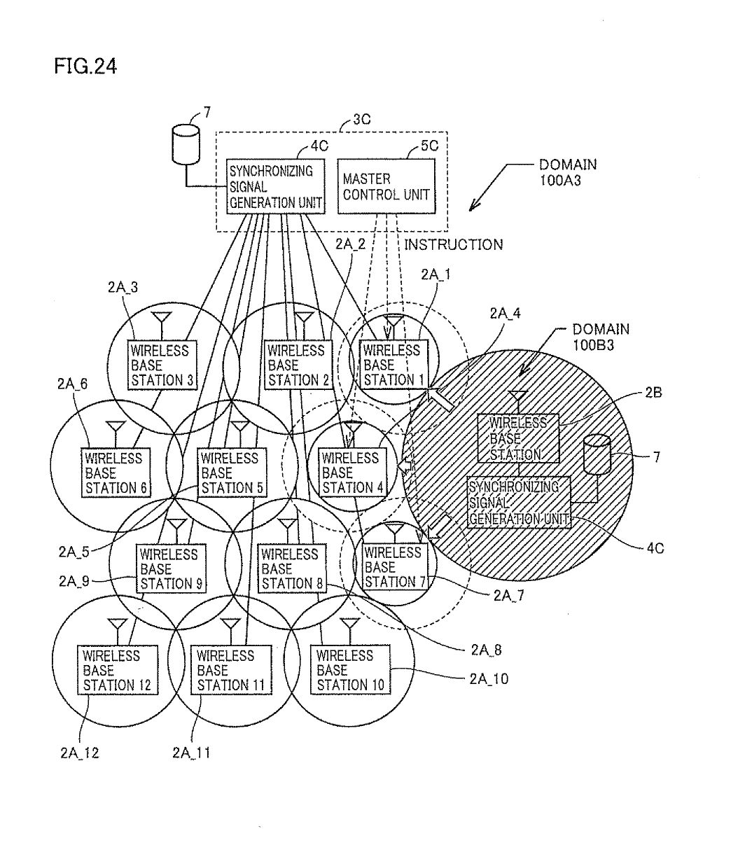

Referring to FIGS. 23 and 24, interference occurring when a UPS signal cannot be received properly at synchronizing signal generation unit 4C (FIG. 22), and a method of suppression thereof will be described hereinafter.

The occurrence of interference caused by deviation in the transmission/reception timing has been already described with reference to FIG. 2. Therefore, details thereof will not be repeated.

In the case where the transmission/reception timing cannot be synchronized in wireless communication system SYS3 according to the present embodiment, master control unit 5C of control device 3C adjusts the cell range relative to each wireless base station 2 so as to suppress occurrence of interference.

FIG. 23 represents an example of a cell arrangement of wireless communication system SYS3 according to the third embodiment. FIG. 24 represents an example of a cell arrangement immediately after the synchronizing signal accuracy falls below the predetermined level at wireless communication system SYS3 shown in FIG. 23.

Wireless communication system SYS3 shown in FIG. 23 will be described as an example. In wireless communication system SYS3 shown in FIG. 23, it is assumed that twelve wireless base stations 2A_1 to 2A_12 belong to domain 100A3, and one wireless base station 2B belongs to domain 100B3. Now, synchronizing signal generation unit 4C of domain 100A3 is disabled from properly receiving a GPS signal.

At this stage, a wireless base station adjacent to only a wireless base station belonging to the common domain 100A3 is not affected by the transmission/reception timing of domain 100B3. In view of wireless base station 2A_2, for example, four wireless base stations 2A_1, 2A3, 2A_4 and 2A5 are located adjacently, all belonging to domain 100A3. Therefore, even if the synchronizing signal used at domain 100A3 is deviated from the synchronizing signal used at domain 100B3, interference will not occur between wireless base stations 2A_1 to 2A_5.

In contrast, wireless base station 2A_1 is adjacent to two wireless base stations 2A_2 and 2A_4 belonging to domain 100A3, as well as to a wireless base station 2B belonging to domain 100B3. Therefore, if the synchronizing signal used at domain 100A3 is deviated from the synchronizing signal used at domain 100B3, interference will occur between wireless base station 2A_1 and wireless base station 2B.

In such an event in wireless communication system SYS3 of the present embodiment, master control unit 5C identifies a wireless base station 2 whose occurrence of interference should be suppressed, and applies to the identified wireless base station(s) 2 an instruction to reduce or cut the transmission power such that the cell range of wireless base station 2 of interest is reduced. Namely, as shown in FIG. 24, each of wireless base stations 2A_1, and 2A_7, among wireless base stations 2 belonging to domain 100A3, and adjacent to wireless base station 213 belonging to domain 100B3, has the cell range of its own station narrowed down to a range that does not overlap with the cell range of wireless base station B.

In other words, master control unit 5C reduces the transmission power of a wireless base station 2 arranged adjacent to wireless base station 2 connected to a synchronizing signal generation unit 4C differing from synchronizing signal generation unit 4C connected to the relevant wireless base station 2, down to a level avoiding overlapping with the reachable range of transmission power of an adjacent wireless base station 2 (hatched region).

Accordingly, interference with a terminal device located across a different domain can be reduced. Such a process allows the area where the conversation and/or communication service is stopped to be minimized even in the case where a GPS signal cannot be received properly, i.e. when the accuracy of a synchronizing signal generated by synchronizing signal generation unit 4C cannot be ensured.

<Configuration of Wireless Base Station>

A configuration of wireless base station 2 according to the present embodiment will be described hereinafter.

The hardware configuration of wireless base station 2 according to the third embodiment has been described already with reference to FIG. 5. Therefore, detailed description thereof will not be repeated.

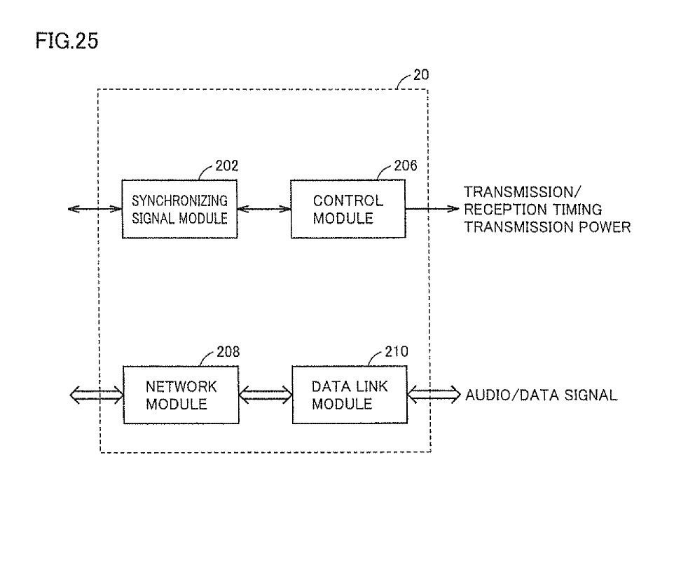

FIG. 25 represents an example of a processing structure of a control unit 20 in a wireless base station according to the third embodiment.

Referring to FIG. 25, control unit 20 includes, as the processing structure, a synchronizing signal module 202, a control module 206, a network module 208, and a data link module 210.

Synchronizing signal module 202 applies an internal instruction to control module 206 based on the synchronizing signal from synchronizing signal generation unit 4C (FIG. 22) received via synchronizing signal I/F 29 (FIG. 5).

Control module 206 applies the transmission/reception timing to coding/decoding circuit 24 (FIG. 5) based on an internal instruction from synchronizing signal module 202. Namely, synchronizing signal module 202 and control module 206 adjust the transmission/reception timing with a terminal device according to the synchronizing signal.

Control module 206 adjusts the transmission power according to an instruction from master control unit 5C that will be described afterwards. Specifically, when the accuracy of the synchronizing signal generated at its own connected synchronizing signal generation unit 4C falls below a predetermined level, an instruction is transmitted from master control unit 5C. In response, control module 206 reduces or cuts the transmission power (modifying the transmission strength) so as to narrow the cell range of its own station.

Network module 208 assumes the network layer function of the so-called OSI model. In other words, network module 208 performs routing and the like of audio/data transferred between the exchanger and a terminal device.

Data link module 210 assumes the data link layer function of the so-called OSI model. In other words, data link module 210 controls the delivery of a signal between a wireless base station 2 (FIG. 22) and a terminal device.

<Configuration of Server Device>

The configuration of server device 6C according to the present embodiment has been described already with reference to FIGS. 7-9. Therefore, details thereof will not be repeated.

<Synchronizing Signal Generation Unit>

Synchronizing signal generation unit 4C according to the present embodiment generates a synchronizing signal based on a GPS signal received from GPS satellite 12, and allows generation of a synchronizing signal having an accuracy of a level identical to that of a synchronizing signal based on a GPS signal for a predetermined period of time, even in the case where reception of a GPS signal is interrupted. Such a function is referred to as a “hold over” function. For example, synchronizing signal generation unit 4C can continuously generate a synchronizing signal, even if a GPS signal cannot be received, for approximately 24 hours.

Although a GPS module having such a hold over function is relatively costly, a configuration in which one synchronizing signal generation unit 4C is shared among a plurality of wireless base stations 2, as in wireless communication system SYS3 of the present embodiment, allows a UPS module with a hold over function, having high accuracy and reliability, to be employed while suppressing the entire cost of the system.

It is to be noted that synchronizing signal generation unit 4C will not be able to generate a synchronizing signal at a timing identical to that of a synchronizing signal generation unit 4C of another domain unless a GPS signal is received within a predetermined period, even if such a hold over function is provided.

Synchronizing signal generation unit 4C according to the present embodiment outputs a synchronizing signal in which is contained information indicating the generation accuracy of the relevant synchronizing signal according to the reception state at synchronizing signal generation unit 4C (currently receiving GPS properly, in hold over state, out of hold over state), in addition to the information indicating its own generated timing. Master control unit 5C receiving this synchronizing signal can identify the accuracy of the synchronizing signal generated at synchronizing signal generation unit 4C.

It is to be noted that the generation accuracy of a synchronizing signal may be degraded due to some cause even in the case where a GPS signal is received properly. Therefore, the generation accuracy of a synchronizing signal may be evaluated based on the variation (dispersion) of jitter in the synchronizing signal generated at synchronizing signal generation unit 4C. In this case, information indicating the generation accuracy of a synchronizing signal may include information indicating that the synchronizing signal accuracy has fallen below a predetermined level, and/or a value of the accuracy of the synchronizing signal.

<Master Control Unit>

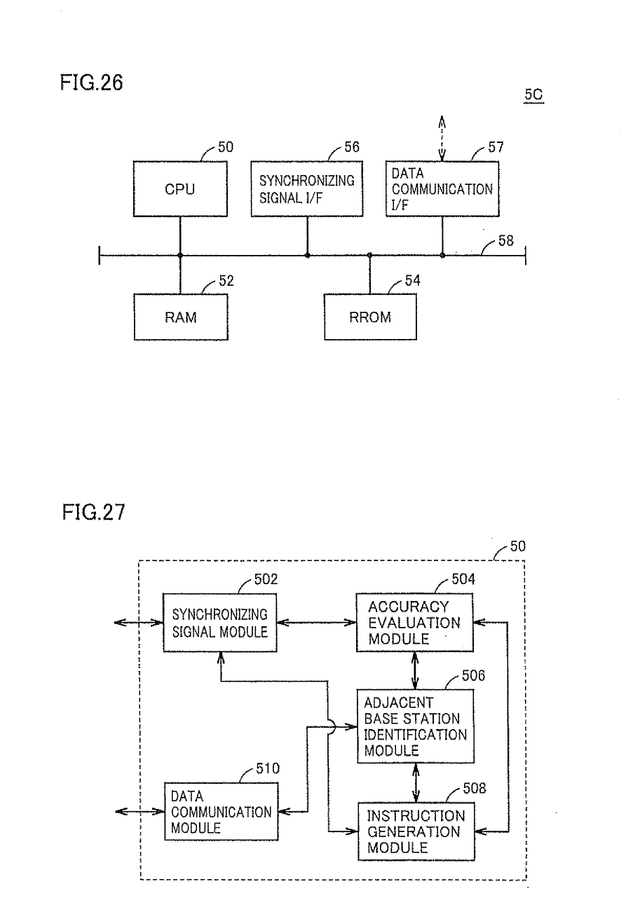

A configuration of a master control unit 5C according to the present embodiment will be described hereinafter with reference to FIGS. 26 and 27.

FIG. 26 represents an example of a hardware configuration of master control unit 5C of the third embodiment. FIG. 27 shows an example of a processing structure provided by a CPU 50 shown in FIG. 26.

Referring to FIG. 26, a master control unit 5C according to the present embodiment includes a CPU 50, a RAM 52, a PROM (Programmable Read Only Memory) 54, a synchronizing signal interface (hereinafter, referred to as “synchronizing signal I/F”) 56, and a data communication interface (hereinafter, also referred to as “data communication I/F”) 57. Each of these elements is configured to allow data communication with each other via an internal bus 58.

CPU 50 that is an operation device transfers a program code prestored in PROM 54 or the like to RAM 52 to execute various processing according to the relevant program code. RAM 52 stores, in addition to the program code executed by CPU 50, various work data required for the execution of a program code.

Synchronizing signal I/F 56 receives a synchronizing signal transmitted from a synchronizing signal generation unit 4C (FIG. 22), and provides the received contents to CPU 50. Synchronizing signal I/F 56 is connected to each wireless base station 2 belonging to a corresponding domain (FIG. 22) via signal line 8C to transmit an instruction generated by CPU 50 by a process that will be described afterwards to wireless base station 2 of interest.

Data communication I/F 57 is connected to a data line 10C to provide the access to a server device 6C (FIG. 22).

Referring to FIG. 27, CPU 50 includes, as a control structure, a synchronizing signal module 502, an accuracy evaluation module 504, an adjacent base station identification module 506, an instruction generation module 508, and a data communication module 510.

Synchronizing signal module 502 provides a synchronizing signal from synchronizing signal generation unit 4C (FIG. 22) received via synchronizing signal I/F 56 (FIG. 26) to accuracy evaluation module 504.

Accuracy evaluation module 504 determines whether the accuracy of the synchronizing signal generated at connected synchronizing signal generation unit 4C maintains a predetermined level or not. Namely, accuracy evaluation module 504 provides the function to determine whether the accuracy of the synchronizing signal generated at a corresponding synchronizing signal generation unit 4C is below a predetermined level. When a determination is made that the accuracy of the synchronizing signal is below the predetermined level, accuracy evaluation module 504 provides the evaluation result to an adjacent base station identification module 506.

Accuracy evaluation module 504 also determines whether the accuracy of synchronizing signal generated at the corresponding synchronizing signal generation unit 4C has recovered to a predetermined level, after falling down to the predetermined level. Namely, accuracy evaluation module 504 determines whether reception of a GPS signal has been resumed or not when corresponding synchronizing signal generation unit 4C is in an out of hold over state. When a determination is made that the accuracy of the synchronizing signal has recovered to the predetermined level, the accuracy evaluation module 504 provides the evaluation result to adjacent base station identification module 506.

Adjacent base station identification module 506 supplies an internal instruction to data communication module 510 and refers to server device 6C (FIG. 22) to identify any of wireless base stations 2 belonging to a corresponding domain that is adjacent to a wireless base station 2 belonging to another domain. Namely, when the accuracy of the synchronizing signal generated at the corresponding synchronizing signal generation unit 4C is below a predetermined level, adjacent base station identification module 506 refers to server device 6C that is a management unit to determine whether there is a connected wireless base station 2, among other wireless base stations 2 arranged adjacent to wireless base station 2 of interest connected to corresponding synchronizing signal generation unit 4C, connected to synchronizing signal generation unit 4C differing from the relevant synchronizing signal generation unit 4C.

When there is a wireless base station 2 adjacent to a wireless base station belonging to another domain, among wireless base stations 2 belonging to the corresponding domain, adjacent base station identification module 506 provides information identifying the relevant wireless base station 2 to instruction generation module 508.

Instruction generation module 508 generates, based on the information of adjacent base station identification module 506, an instruction designating reduction or cutting (modification of transmission strength) of the transmission power to narrow the cell range of wireless base station 2 of interest. Then, instruction generation module 508 applies an internal instruction to synchronizing signal module 502 to transmit the generated instruction to wireless base station 2 of interest.

Thus, when there is arranged adjacently a wireless base station 2 connected to a synchronizing signal generation unit 4C differing from synchronizing signal generation unit 4C whose accuracy of the synchronizing signal is below a predetermined level, adjacent base station identification module 506 instructs wireless base station 2 of interest to reduce the transmission power.

Furthermore, upon notification of the accuracy of the synchronizing signal recovering to the predetermined level from accuracy evaluation module 504, instruction generation module 508 generates an instruction designating restoration of the transmission power towards wireless base station 2 having the transmission power reduced or cut. Then, instruction generation module 508 provides an internal instruction to synchronizing signal module 502 to transmit the generated instruction to wireless base station 2 of interest. Specifically, when the accuracy of the synchronizing signal recovers to the predetermined level, instruction generation module 508 instructs restoration of the transmission power to a wireless base station 2 instructed to have the transmission power reduced, among wireless base stations 2 connected to synchronizing signal generation unit 4C whose accuracy of the synchronizing signal has recovered to the predetermined level.

In the case where the information flowing through signal line 8C is a broadcast message, i.e. not a communication scheme in which data is transmitted to only a certain wireless base station 2, synchronizing signal module 502 adds identification information or the like of a wireless base station to be transmitted to the instruction from instruction generation module 508 for transmission. Accordingly, each wireless base station 2 may selectively receive only an instruction having its own station identification number added.

<Processing Procedure>

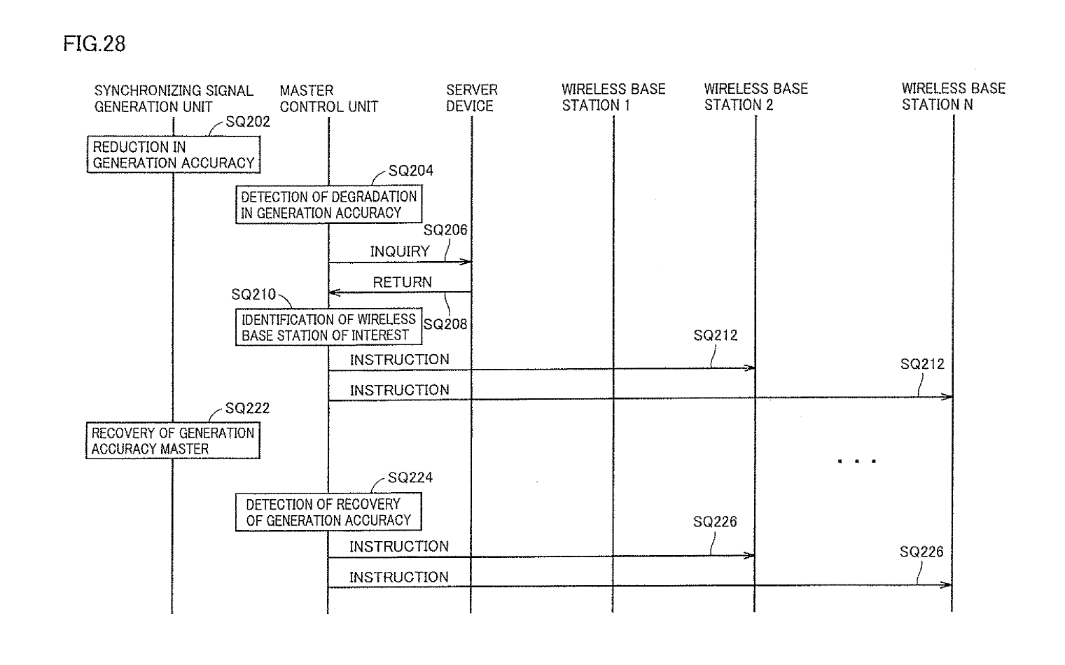

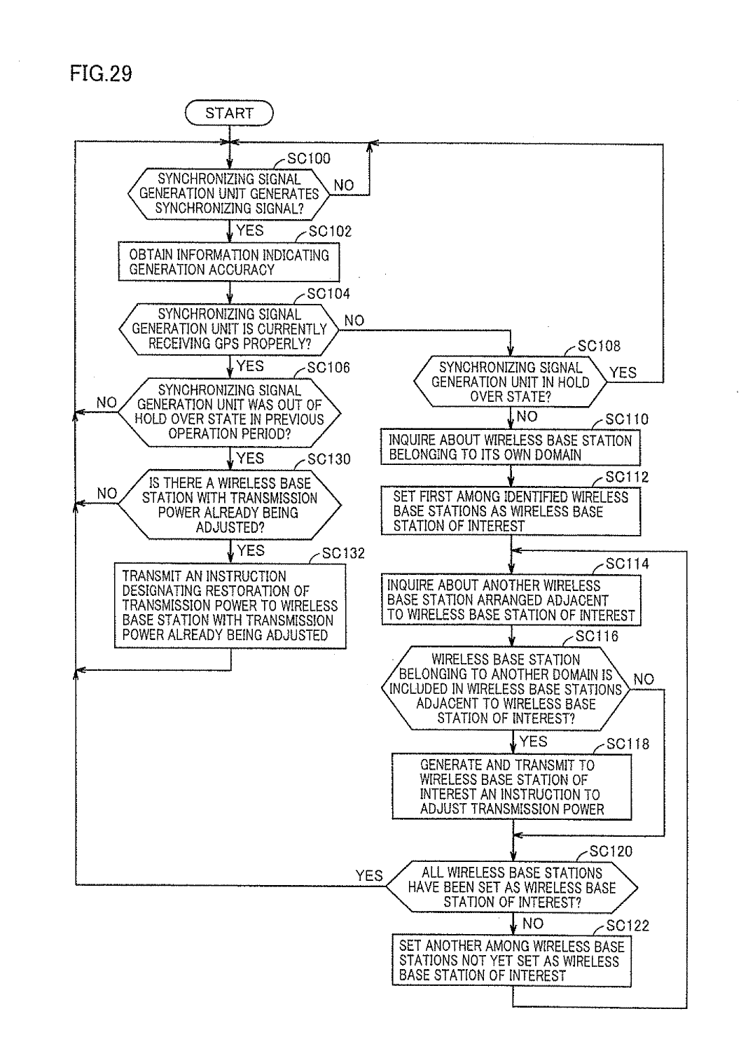

The processing procedure of the present embodiment will be described hereinafter with reference to FIGS. 28 and 29.

FIG. 28 represents the sequence of the process at each element in wireless communication system SYS3 according to the third embodiment. FIG. 29 is a flowchart of an operation of control device 3C according to the third embodiment.

(1. Overall Sequence)

Referring to FIG. 28, it is assumed that the generation accuracy of the synchronizing signal of synchronizing signal generation unit 4C is degraded by some cause (sequence SQ202). Master control unit 5C detects reduction in the generation accuracy of the synchronizing signal (sequence SQ204). In response, master control unit 5C inquires of server device 6C about the required information to identify a wireless base station adjacent to a wireless base station belonging to another domain, among wireless base stations belonging to the corresponding domain (sequence SQ206).

When the required information is returned from server device 6C (sequence SQ208), master control unit 5C identifies the wireless base station of interest whose transmission power is to be reduced or cut to narrow the cell range (sequence SQ210). Then, master control unit 5C transmits to the wireless base station of interest an instruction to adjust the transmission power (sequence SQ212). In the example shown in FIG. 28, it is assumed that wireless base station 2 and wireless base station N are the subjects to have the transmission power suppressed, among wireless base stations 1, 2, . . . , N belonging to the corresponding domain. Namely, the transmission power of wireless base station 2 and wireless base station N, among wireless base stations 1, 2, . . . , N, has a smaller value as compared to the level of the normal transmission power.

Then, it is assumed that the synchronizing signal generation accuracy of synchronizing signal generation unit 4C has recovered (sequence SQ222). Upon detecting that the synchronizing signal generation accuracy has recovered (sequence SQ224), master control unit 5C transmits an instruction designating restoration of the transmission power to the wireless base station instructed to have the transmission power reduced or cut (modification of transmission strength (sequence SQ226). Thus, wireless communication system SYS3 can provide the normal communication area.

(2. Operation Flow)

The operation flow at control device 3C will be described hereinafter.

Referring to FIG. 29, CPU 50 (FIG. 26) of master control unit 5C in control device 3C determines whether synchronizing signal generation unit 4C of control device 3C (FIG. 22) has generated a synchronizing signal or not (step SC100). If a synchronizing signal is not generated (NO at step SC100), the process at step SC100 is repeated.

If a synchronizing signal is generated (YES at step SC 100), CPU 50 of master control unit 5C obtains information indicating the synchronizing signal generation accuracy included in the generated synchronizing signal (step SC102). Then, CPU 50 of master control unit 5C determines whether synchronizing signal generation unit 4C is currently receiving GPS properly (step SC104). Namely, CPU 50 of master control unit 5C determines whether the accuracy of the synchronizing signal generated at synchronizing signal generation unit 4C is below a predetermined level.

When synchronizing signal generation unit 4C is currently receiving GPS properly (YES at step SC104), CPU 50 of master control unit 5C determines whether synchronizing signal generation unit 4C was in an out of hold over state in the previous operation period (step SC106). Namely, CPU 50 of master control unit 5C determines whether the accuracy of the synchronizing signal generated at corresponding synchronizing signal generation unit 4C has recovered to the predetermined level subsequent to falling below the predetermined level. In other words, CPU 50 of master control unit 5C determines whether reception of a GPS signal has been resumed or not when synchronizing signal generation unit 4C is in an out of hold over state.

In the case where synchronizing signal generation unit 4C was in an out of hold over state in the previous operation period (YES at step SC106), control proceeds to step SC130. When synchronizing signal generation unit 4C was not in an out of hold over state in the previous operation period (NO at step SC106), the subsequent processing is skipped, and the processing of steps SC 100 and et seq. is repeated.

In contrast, when synchronizing signal generation unit 4C is not currently receiving GPS properly (NO at step SC104), CPU 50 of master control unit 5C determines whether synchronizing signal generation unit 4C is in a hold over state (step SC108). If synchronizing signal generation unit 4C is in a hold over state (YES at step SC108), the subsequent processing is skipped, and the processing of steps SC100 and et seq. is repeated.

If synchronizing signal generation unit 4C is not in a hold over state (NO at step SC108), i.e., synchronizing signal generation unit 4C is in an out of hold over state, CPU 50 of master control unit 5C executes the transmission power adjustment process set forth below.

Namely, CPU 50 of master control unit 5C inquires of server device 6C about a wireless base station belonging to its domain (step SC110). Specifically, in response to CPU 50 of master control unit 5C transmitting the identification information of its own domain to server device 6C, CPU 60 of server device 6C refers to domain list 662 stored in data storage unit 66 to return the identification information of an adjacent base station belonging to the domain corresponding to the inquired identification information. Namely, master control unit 5C refers to domain list 662 of server device 6C to identify a wireless base station belonging to its own domain.

Then, CPU 50 of master control unit 5C sets the first in the wireless base stations identified at step SC110 as the wireless base station of interest (step SC112). Then, CPU 50 of master control unit 5C inquires of server device 6C about another wireless base station arranged adjacent to the wireless base station of interest (SC114). Specifically, in response to CPU 50 of master control unit 5C transmitting identification information of a wireless base station of interest to server device 6C, CPU 60 of server device 6C refers to neighbor list 664 stored in data storage unit 66 to return identification information of an adjacent base station corresponding to the inquired identification information. Specifically, master control unit 5C refers to neighbor list 664 of server device 6C to identify another wireless base station adjacent to the wireless base station of interest.

Then, CPU 50 of master control unit 5C determines whether there is a wireless base station belonging to another domain, as a wireless base station adjacent to the wireless base station of interest obtained at step SC114 (step SC116).

More specifically, CPU 50 of master control unit 5C determines whether all the wireless base stations adjacent to the wireless base station of interest, returned from server device 6C, are included in the list of wireless base stations belonging to its own domain obtained at step SC110. If there is any wireless base station adjacent to the wireless base station of interest not included in the list of wireless base stations belonging to its own domain, a determination is made that the wireless base station of interest is adjacent to a wireless base station belonging to another domain. Specifically, master control unit 5C refers to domain list 662 of server device 6C to identify a synchronizing signal generation unit to which is connected another wireless base station arranged adjacent to the obtained wireless base station of interest.

When a wireless base station belonging to another domain is included as a wireless base station adjacent to the wireless base station of interest (YES at step SC116), CPU 50 of master control unit 5C generates an instruction to adjust the transmission power, and provides the generated instruction to the wireless base station of interest (step SC118). Then control proceeds to step SC120.

When a wireless base station belonging to another domain is not included as a wireless base station adjacent to the wireless base station of interest (NO at step SC116), the process of step SC118 is skipped and control proceeds to step SC120. Namely, when there is not arranged adjacently a wireless base station 2 connected to a synchronizing signal generation unit 4C differing from synchronizing signal generation unit 4C whose synchronizing signal accuracy is below a predetermined level, master control unit 5C maintains the power transmission of wireless base station 2 of interest.

Then, CPU 50 of master control unit 5C determines whether all the wireless base stations identified at step SC110 have been taken as a wireless base station of interest (step SC120). When there is a wireless base station not yet taken as a wireless base station of interest among the wireless base stations identified at step SC 110 (NO at step SC120), CPU 50 of master control unit 5C sets another wireless base station as the wireless base station of interest from the wireless base stations not yet taken as a wireless base station of interest (step SC122). Then, the processing of steps SC114 and et seq. is repeated.

As shown in steps SC108-SC122, when the synchronizing signal accuracy is below a predetermined level, master control unit 5C refers to server device 6C to determine whether there is, among other wireless base stations 2 arranged adjacent to wireless base station 2 of interest connected to synchronizing signal generation unit 4C whose synchronizing signal accuracy is below a predetermined level, a wireless base station 2 connected to a synchronizing signal generation unit 4C differing from the relevant synchronizing signal generation unit 4C. Then, master control unit 5C instructs, when there is arranged adjacently a wireless base station 2 connected to a synchronizing signal generation unit 4C differing from synchronizing signal generation unit 4C whose synchronizing signal accuracy is below a predetermined level, wireless base station 2 of interest to reduce the transmission power.

CPU 50 of master control unit 5C reduces the transmission power of the wireless base station of interest, avoiding overlapping with the reachable range of transmission power at a wireless base station belonging to another domain. Therefore, the transmission power subsequent to reduction may be determined dynamically based on the distance from an adjacent wireless base station belonging to a domain differing from that of the wireless base station of interest and the transmission power of that adjacent wireless base station. Furthermore, a distance without interference (transmission power) from an adjacent wireless base station may be determined in advance, and reduce the transmission power down to the defined value (for example, ½ the normal transmission power). Further alternatively, the transmission power may be set to zero (output stopped) so as to avoid interference completely with an adjacent wireless base station.

In contrast, when the wireless base stations identified at step SC110 have all been set as a wireless base station of interest (YES at step SC120), the transmission power adjustment process ends, and the processing of steps SC100 and et seq. is repeated.

At step SC, CPU 50 of master control unit 5C determines whether there is a wireless base station already having its transmission power adjusted (step SC 130). When there is a wireless base station already having the transmission power adjusted (YES at step SC130), CPU 50 of master control unit 5C transmits an instruction designating restoration of the transmission power to the wireless base station already having its transmission power adjusted (step SC132). In other words, CPU 50 of master control unit 5C causes wireless communication system SYS3 to provide a normal communication area in association with recovery of the synchronizing signal generation accuracy.

Specifically, when the synchronizing signal accuracy has recovered to the predetermined level, master control unit 5C instructs restoration of the transmission power for a wireless base station 2 instructed to have transmission power reduced, among wireless base stations 2 connected to synchronizing signal generation unit 4C whose synchronizing signal accuracy has recovered to a predetermined level.

When there is not a wireless base station already having the transmission power adjusted (NO at step SC130), or subsequent to execution of step SC132, the transmission power restoration process ends. The processing of steps SC100 and et seq. is repeated.

Since the wireless communication system of the present embodiment shares a synchronizing signal generation unit generating a synchronizing signal among a plurality of wireless base stations, a GPS module of higher accuracy and reliability can be employed while suppressing the cost of the entire system.

Furthermore, the wireless communication system of the present embodiment allows the transmission power to be adjusted to suppress interference with respect to a wireless base station connected to another synchronizing signal generation unit even in the case where a signal from a satellite including time information (for example, GPS signal) cannot be received at the synchronizing signal generation unit due to some cause and the accuracy of the generated synchronizing signal cannot be maintained. As a result, the conversation and/or communication service can be continued to the best possible degree even in the case where the accuracy of the synchronizing signal is not ensured.

### Fourth Embodiment

The above-described third embodiment is based on a configuration in which a master control unit 5C (control device 3C) arranged in domain unit adjusts the transmission power of wireless base station 2 belonging to the corresponding domain. The fourth embodiment is directed to a configuration in which a single master control unit controls a plurality of domains.

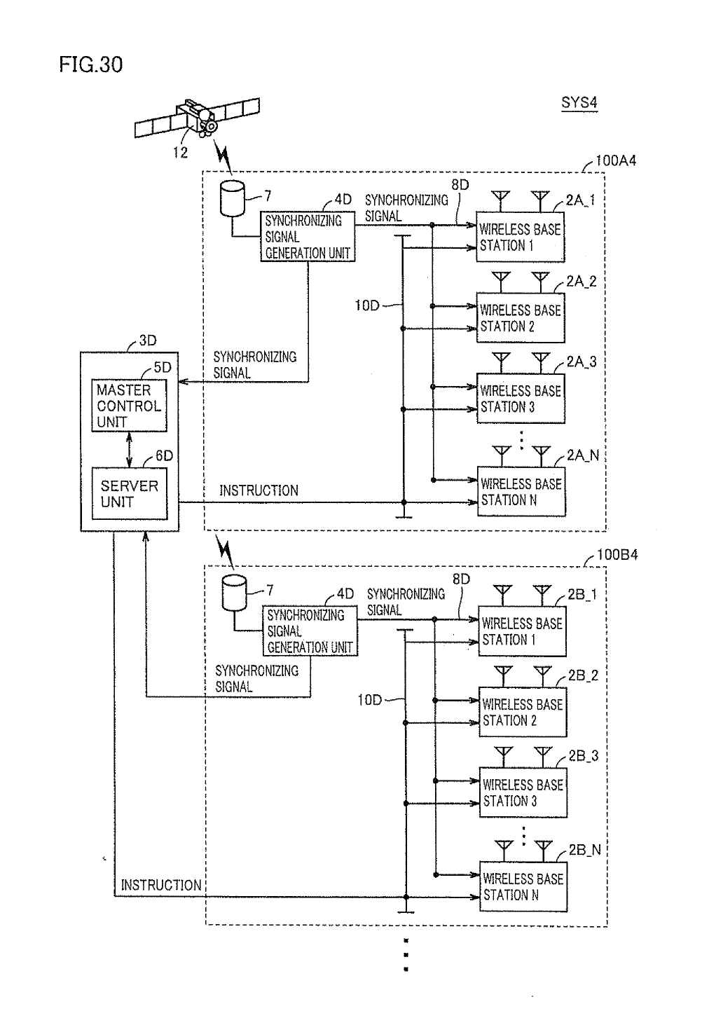

FIG. 30 is a schematic view of a configuration of a wireless communication system SYS4 according to the fourth embodiment. Likewise with wireless communication system SYS3 set forth above, wireless communication system SYS4 according to the present embodiment is typically directed to a high speed data communication system such as a cellular phone system of the TDMA scheme and CDMA scheme, a PHS system, the OFDMA scheme, and the like.

Referring to FIG. 30, wireless communication system SYS4 includes a plurality of domains 100A4, 100B4, and a control device 3D. Each of domains 100A4 and 100B4 includes a plurality of wireless base stations 2, and a synchronizing signal generation unit 4D. Wireless base station 2 and synchronizing signal generation unit 4D are similar to wireless base station 2 and synchronizing signal generation unit 4D described in the previous third embodiment. Therefore, detailed description thereof will not be repeated. Each wireless base station shown in FIG. 30 is assigned a reference numeral such as “2A_1”, “2A_2”, . . . , based on a combination of the domain to which it belongs and the identification information in the domain.

Control device 3D includes a master control unit 5D and a server unit 6D. Master control unit 5D integrally controls domains 100A4 and 100B4. Specifically, master control unit 5D is connected to a synchronizing signal generation unit 4D arranged in each of domains 100A4 and 100B4, and evaluates the synchronizing signal generation accuracy from each synchronizing signal generation unit 4D. When the generation accuracy of any synchronizing signal is reduced, master control unit 5D adjust the transmission power of a particular wireless base station 2 to reduce the interference (noise) between a wireless base station 2 belonging to domain 100A4 and a wireless base station 2 belonging to domain 100B4.

Server unit 6D is basically similar to server device 6C constituting wireless communication system SYS3 according to the third embodiment set forth above, provided that server unit 6D of the present embodiment further holds a transmission power management list.

The remaining configuration and function of wireless communication system SYS4 of the present embodiment are similar to those of wireless communication system SYS3 of the third embodiment. Therefore, detailed description will not be repeated.

<Summary of Interference Suppression Processing>

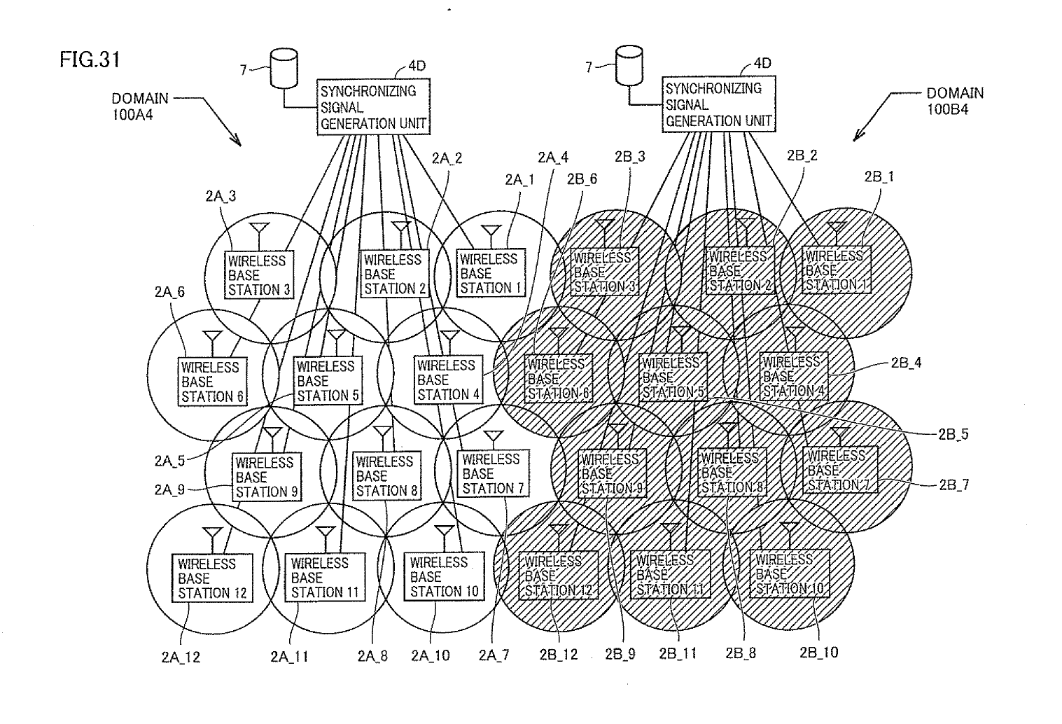

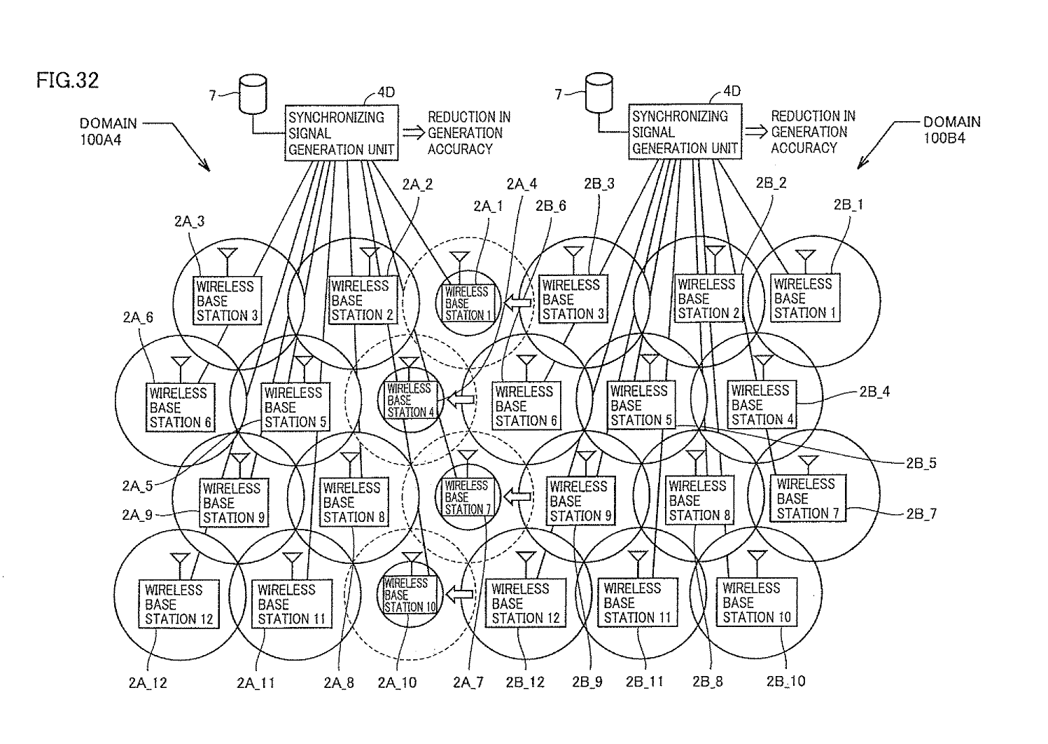

The process of suppressing interference at wireless communication system SYS4 according to the present embodiment will be described hereinafter with reference to FIGS. 31 and 32.

FIG. 31 represents an example of a cell arrangement of wireless communication system SYS4 according to the fourth embodiment. FIG. 32 is a diagram to describe the cell range when the accuracy of the synchronizing signal in domain 100A4 is below a predetermined level at wireless communication system SYS4 shown in FIG. 31.

Referring to FIG. 31, it is assumed that the plurality of wireless communication systems are arranged in a beehive manner in wireless communication system SYS4 according to the present embodiment. Among these wireless base stations, four wireless base stations 2A_1, 2A_4, 2A_7, and 2A_10 belonging to domain 100A4 are adjacent to a wireless base station belonging to domain 100B4. Conversely, four wireless base stations 2B_3, 2B_6, 2B_9 and 2B_12 belonging to domain 100B4 are adjacent to a wireless base station belonging to domain 100A4.

By way of example, synchronizing signal generation unit 4D of domain 100B4 is mounted with a GPS module of higher reliability, as compared to synchronizing signal generation unit 4D of domain 100A4. In other words, synchronizing signal generation unit 4D of domain 100B4 can maintain a hold over state longer as compared to synchronizing signal generation unit 4D of domain 100A4. In the case of employing such a configuration, the time when the accuracy of the generated synchronizing signal being degraded will differ in the event of both synchronizing signal generation units 4D of domains 100A4 and 100B4 not being able to receive a GPS signal. The operation in such an event will be described hereinafter.

It is assumed that the generation accuracy of a synchronizing signal generated at synchronizing signal generation unit 4D of domain 100A4 falls below a predetermined level. It is assumed that the accuracy of the synchronizing signal generated at synchronizing signal generation unit 4D of domain 10084 is maintained at this predetermined level. Accordingly, as shown in FIG. 32, the four wireless base stations 2A_1, 2A_4, 2A_7 and 2A_10 as arranged adjacent to the wireless base station belonging to domain 100B4, among the wireless base stations belonging to domain 100A4, are instructed to have the transmission power reduced or cut (modification of transmission strength). In other words, the cell range of the four wireless base stations 2A_1, 2A_4, 2A_7 and 2A_10 belonging to domain 100A4 is modified to avoid overlapping with the cell range of another wireless base station belonging to domain 100B4.

Then, it is assumed that the generation accuracy of the synchronizing signal generated at synchronizing signal generation unit 4D of domain 100B4 falls below a predetermined level. In this case, the four wireless base stations 2A_1, 2A_4, 2A_7 and 2A_10 belonging to domain 100A4 among the wireless base stations located in the vicinity of the border between domain 100A4 and domain 10084 already have the transmission power reduced or cut. Therefore, the four wireless base stations 2B_3, 2B_6, 2B_9 and 2B_12 belonging to domain 10084, arranged adjacent to the wireless base stations already reduced or cut, will not exhibit interference with a wireless base station belonging to domain 100A4. In other words, the transmission power of the four wireless base stations 2B_3, 2B_6, 2B_9 and 2B_12 belonging to domain 100B4 does not have to be reduced or cut.

Therefore, even if the synchronizing signal generation accuracy at corresponding synchronizing signal generation unit 4D in wireless communication system SYS4 of the present embodiment falls below a predetermined level, the transmission power of wireless base station 2 of interest is maintained if the transmission power of another wireless base station 2 belonging to an adjacent another domain is already reduced. The range of providing service can be maintained to the best possible degree by employing such processing.

<Configuration of Control Device>

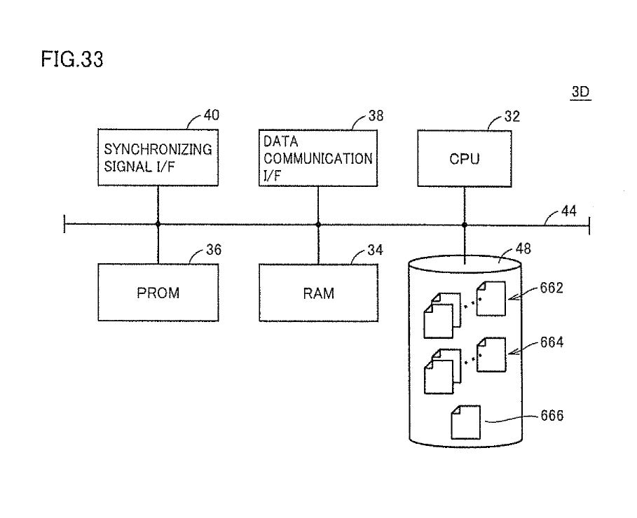

A configuration of control device 3D according to the present embodiment will be described with reference to FIGS. 33-36.

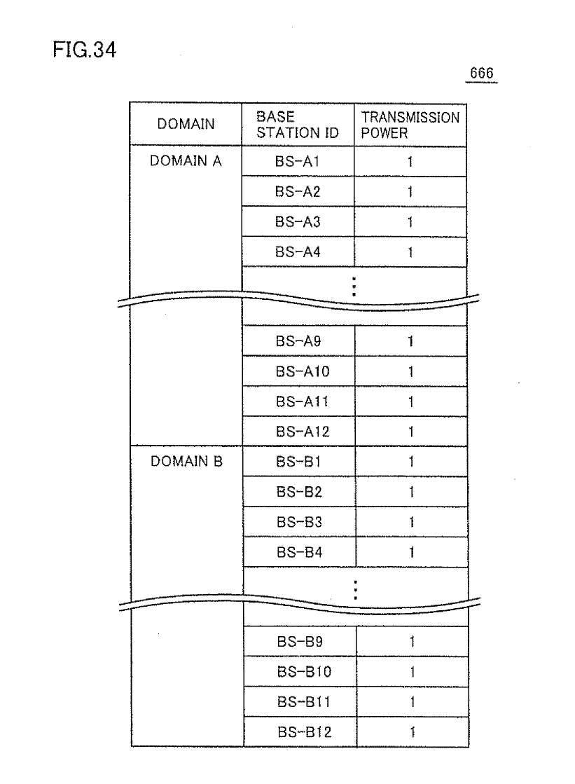

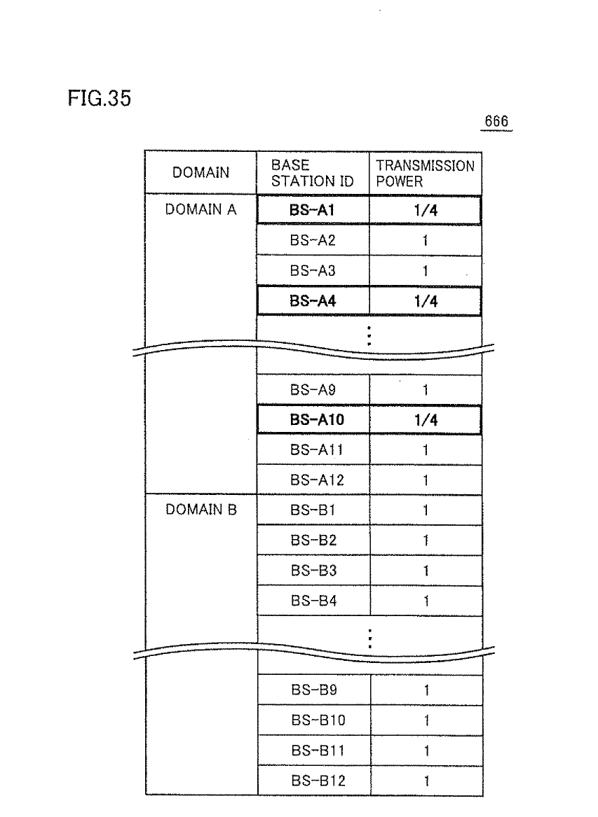

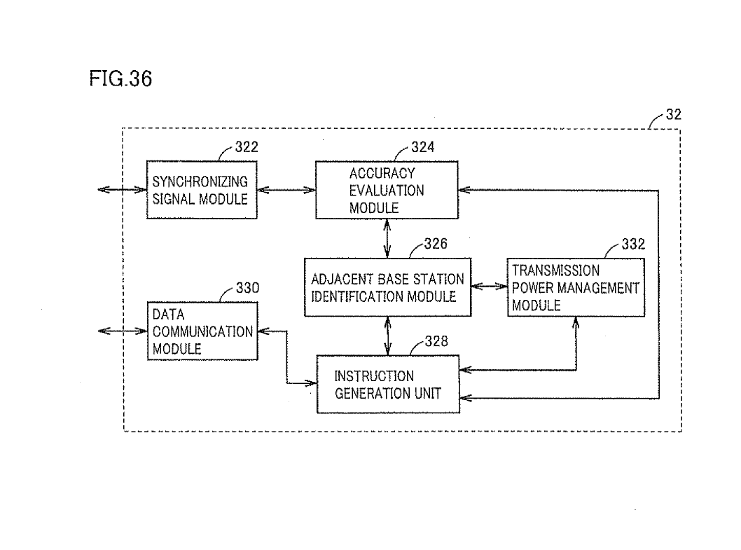

FIG. 33 represents an example of a hardware configuration of control device 3D according to the fourth embodiment. FIG. 34 represents an example of the contents in a transmission power management list 666 shown in FIG. 33. FIG. 35 represents an updated example of the contents in transmission power management list 666 shown in FIG. 34. FIG. 36 represents an example of a processing configuration provided by CPU 32 of FIG. 33.

Referring to FIG. 33, control device 3D of the present embodiment includes a CPU 32, A RAM 34, a PROM (Programmable Read Only Memory) 36, a data communication interface (hereinafter, also referred to as “data communication I/F”) 38, a synchronizing signal interface (hereinafter, referred to as “synchronizing signal I/F”) 40, and a data storage unit 48. Each of these elements is configured to allow data communication with each other via an internal bus 44.

CPU 32 that is an operation device transfers a program code prestored in PROM 36 or the like to RAM 34 to execute various processing according to the relevant program code. In other words, functions as a master control unit 5D (FIG. 30). RAM 34 stores, in addition to the program code executed by CPU 32, various work data required for the execution of a program code. A program code executed at CPU 32 as well as various constants are stored in advance in PROM 36.

Data communication I/F 38 is connected to each wireless base station 2 belonging to domains 100A4 and 100B4 via data line 10D (FIG. 30) to provide an instruction generated by CPU 32 according to the processing that will be described afterwards to a wireless base station 2 of interest. Synchronizing signal I/F 40 receives a synchronizing signal transmitted from synchronizing signal generation unit 4D (FIG. 30), and provides the received content to CPU 32.

Data storage unit 48 functions as a server unit 6D (FIG. 30), storing a domain list 662, a neighbor list 664, and a transmission power management list 666. Typically, data storage unit 48 is formed of a hard disk device. CPU 32 gains access to the required data in data storage unit 48 via an internal bus 44.

Domain list 662 and neighbor list 664 are similar to those in the above-described third embodiment (refer to FIGS. 8 and 9). Therefore, detailed description thereof will not be repeated.

Transmission power management list 666 includes information indicating the current transmission power state at each wireless base station 2 belonging to each domain. Specifically, as shown in FIG. 34, transmission power management list 666 is a table including “domain”, “base station ID” associated with a relevant domain, and “transmission power” associated with the relevant “base station ID”. In the column of “domain”, information to identify each domain is described, such as “domain A” and “domain B”. In the column of “base station ID”, information to identify a wireless base station 2 belonging to a corresponding domain is described, such as “BS-A1” and “BS-A2”. In the column of “transmission power”, a ratio is described, typically indicating the level of the current transmission power to a power reference value. Specifically, in the case where corresponding wireless base station 2 is transmitting/receiving at a transmission power equivalent to the reference value, “1” is indicated at the column of “transmission power”. In the case where corresponding wireless base station 2 is transmitting/receiving at transmission power equivalent to ¼ the reference value (that is, the cell radius is ½ the standard cell radius), “¼” is indicated. FIG. 35 shows an example of transmission power management list 666 corresponding to the state shown in FIG. 32.

Thus, transmission power management list 666 has its contents updated as needed according to the interference suppression control that will be described afterwards.

Referring to FIG. 36, CPU 32 provides, as a control structure corresponding to master control unit 5D (FIG. 30), a synchronizing signal module 322, an accuracy evaluation module 324, an adjacent base station identification module 326, an instruction generation module 328, a data communication module 330, and a transmission power management module 332.

Synchronizing signal module 322, accuracy evaluation module 324, adjacent base station identification module 326, instruction generation module 328, and data communication module 330 shown in FIG. 36 are similar to the above-described synchronizing signal module 502, accuracy evaluation module 504, adjacent base station identification module 506, instruction generation module 508 and data communication module 510 (all in FIG. 27), respectively. Therefore, detailed description thereof will not be repeated.

The function of instruction generation module 328 is to be noted. When the synchronizing signal accuracy falls below a predetermined level, instruction generation module 328 determines whether to carry out control directed to suppressing interference for a wireless base station 2 of interest, based on the domain to which wireless base station 2 adjacent to wireless base station 2 of interest belongs, and the current transmission power of wireless base station 2 adjacent to wireless base station 2 of interest. Namely, instruction generation module 328 generates an instruction designating reduction or cutting of the transmission power (modifying the transmission strength) to narrow the cell range for a wireless base station 2 of interest, only when a wireless base station 2 adjacent to wireless base station 2 of interest belongs to a different domain and the relevant adjacent wireless base station 2 has not reduced the transmission power.

In other words, instruction generation module 328 determines, when there is arranged adjacently a wireless base station 2 connected to a synchronizing signal generation unit 4D differing from synchronizing signal generation unit 4D whose synchronizing signal accuracy is below a predetermined level, whether reduction of the transmission power has already been instructed to wireless base station 2 arranged adjacently. Instruction generation module 328 maintains the transmission power of wireless base station 2 of interest when reduction of transmission power has already been instructed for the wireless base station 2 arranged adjacently.

Transmission power management module 332 regulates the value of the transmission power at each wireless base station 2 belonging to the domain of interest under control based on the instruction generated by instruction generation module 328. In other words, transmission power management module 332 updates, as needed, the value in transmission power management list 666 (FIGS. 33-35) based on the generated instruction.

Further, transmission power management module 332 responds to a request from instruction generation module 328 to return the current transmission power state (value) at wireless base station 2 of interest.

<Processing Procedure>

The processing procedure at control device 3D of the present embodiment will be described hereinafter.

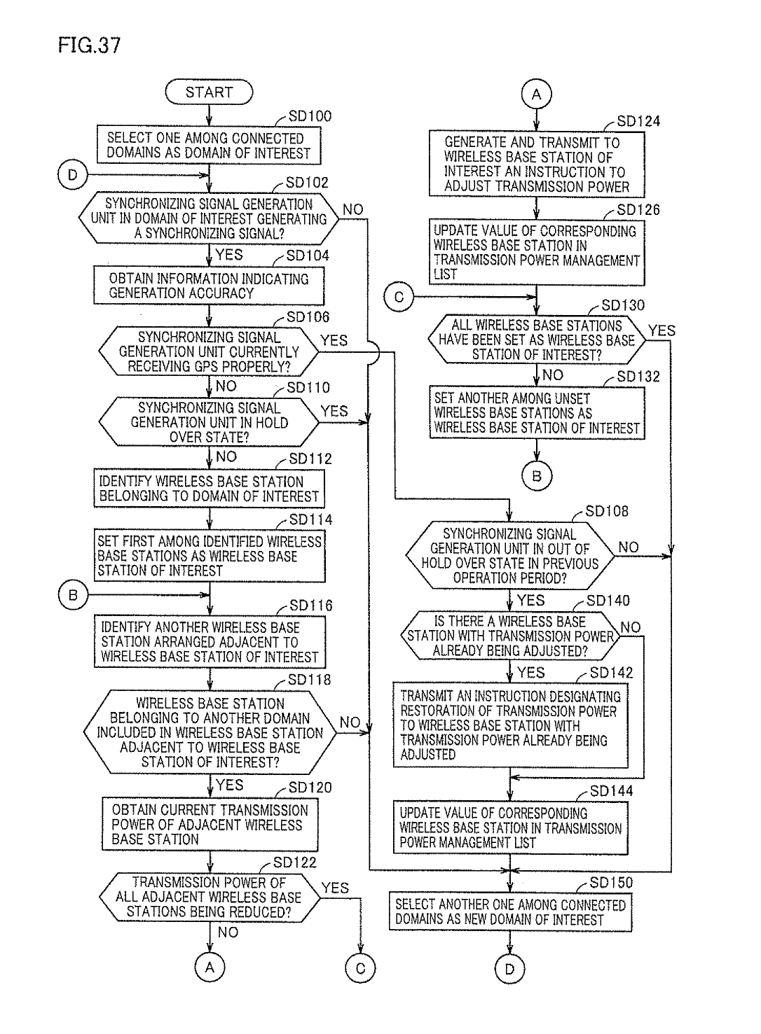

FIG. 37 is a flowchart representing an operation of control device 3D according to the fourth embodiment.

Referring to FIG. 37, CPU 32 (FIG. 26) of control device 3D selects one of a plurality of domains connected as the domain of interest (step SD100). Then, CPU 32 of control device 3D determines whether synchronizing signal generation unit 4D (FIG. 30) belonging to the domain of interest has generated a synchronizing signal (step SD102). If a synchronizing signal is not generated (NO at step SD102), control proceeds to step SD150.

If a synchronizing signal is generated (YES at step SD102), CPU 32 of control device 3D obtains information indicating the synchronizing signal generation accuracy included in the generated synchronizing signal (step SD104). Then, CPU 32 of control device 3D determines whether synchronizing signal generation unit 4D is currently receiving GPS properly (step SD106). Specifically, CPU 32 of control device 3D determines whether the accuracy of the synchronizing signal generated at corresponding synchronizing signal generation unit 4D is below a predetermined level or not.

When synchronizing signal generation unit 4D is currently receiving GPS properly (YES at step SD106), CPU 32 of control device 3D determines whether synchronizing signal generation unit 4D was in an out of hold over state in the previous operation period (step SD108). Namely, CPU 32 of control device 3D determines whether the accuracy of the synchronizing signal generated at corresponding synchronizing signal generation unit 4D has recovered to the predetermined level subsequent to falling below the predetermined level. In other word, CPU 32 of control device 3D determines whether reception of a GPS signal has been resumed or not when synchronizing signal generation unit 4D is in an out of hold over state.

In the case where synchronizing signal generation unit 4D was in an out of hold over state in the previous operation period (YES at step SD108), control proceeds to step SD140. When synchronizing signal generation unit 4D was not in an out of hold over state in the previous operation period (NO at step SD108), the subsequent processing is skipped, and control proceeds to step SD150.

In contrast, when synchronizing signal generation unit 4D is not currently receiving GPS properly (NO at step SD106), CPU 32 of control device 3D determines whether synchronizing signal generation unit 4D is in a hold over state (step SD110). If synchronizing signal generation unit 4D is in a hold over state (YES at step SD110), the subsequent processing is skipped, and control proceeds to step SD150.

If synchronizing signal generation unit 4D is not in a hold over state (NO at step SD110), i.e., synchronizing signal generation unit 4D is in an out of hold over state, CPU 32 of control device 3D executes the transmission power adjustment process set forth below.

Namely, CPU 32 of control device 3D refers to domain list 662 stored in data storage unit 48 to identify a wireless base station belonging to the domain of interest (step SD112).

Then, CPU 32 of control device 3D sets the first in the wireless base stations identified at step SD112 as the wireless base station of interest (step SD114). Then, CPU 32 of control device 3D refers to neighbor list 664 stored in data storage unit 48 to identify another wireless base station adjacent to the wireless base station of interest (step SD116).

Then, CPU 32 of control device 3D determines whether there is a wireless base station belonging to another domain, as a wireless base station adjacent to the wireless base station of interest obtained at step SD116 (step SD118). More specifically, CPU 32 of control device 3D determines whether all the wireless base stations adjacent to the wireless base station of interest are included in the obtained list of wireless base stations belonging to its own domain at step SD112. If there is any wireless base station adjacent to the wireless base station of interest not included in the list of wireless base stations belonging to its own domain, a determination is made that the wireless base station of interest is adjacent to a wireless base station belonging to another domain.

When a wireless base station belonging to another domain is not included as a wireless base station adjacent to the wireless base station of interest (NO at step SD118), the subsequent processing is skipped and control proceeds to step SD150. Namely, for a wireless base station 2 not arranged adjacent to a wireless base station belonging to another domain, CPU 32 of control device 3D maintains the power transmission of that wireless base station.

In contrast, when a wireless base station belonging to another domain is included as a wireless base station adjacent to the wireless base station of interest (YES at step SD118), CPU 32 of control device 3D obtains the current transmission power of the relevant adjacent wireless base station (step SD120). More specifically, CPU 32 of control device 3D refers to transmission power management list 666 stored in data storage unit 48 to obtain the value of the transmission power of another wireless base station adjacent to the wireless base station of interest. Then, CPU 32 of control device 3D determines whether the transmission power of all the wireless base stations belonging to another domain, adjacent to the wireless base station of interest, is currently being reduced (step SD122).

When the transmission power of all the wireless base stations belonging to another domain, adjacent to the wireless base station of interest, is currently being reduced (YES at step SD122), the subsequent processing is skipped, and control proceeds to step SD130. Namely, if the transmission power of all the wireless base stations belonging to another domain, adjacent to the wireless base station of interest, is being reduced, CPU 32 of control device 3D maintains the power transmission of that wireless base station.

In contrast, if the transmission power of all the wireless base stations belonging to another domain, adjacent to the wireless base station of interest, is not reduced (NQ at step SD122), CPU 32 of control device 3D generates an instruction to adjust the transmission power, and provides the generated instruction to the wireless base station of interest (step SD124). Based on the instruction to adjust the transmission power, CPU 32 of control device 3D updates the value of corresponding wireless base station 2 in transmission power management list 666 stored in data storage unit 48 (step SD126). Then, control proceeds to step SD130.

Then, CPU 32 of control device 3D determines whether all the wireless base stations identified at step SD112 have been taken as a wireless base station of interest (step SD130). When there is a wireless base station not yet taken as a wireless base station of interest among the wireless base stations identified at step SD112 (NO at step SD 130), CPU 32 of control device 3D sets another wireless base station as the wireless base station of interest from the wireless base stations not yet taken as a wireless base station of interest (step SD132). Then, the processing of steps SD116 and et seq. is repeated.

As shown in steps SD114-SD116, when the synchronizing signal accuracy is below a predetermined level, CPU 32 of control device 3D adjusts the transmission power of a wireless base station arranged adjacent to a wireless base station belonging to another domain master, among wireless base stations belonging to its own domain, to avoid interference with a wireless base station belonging to another domain.

CPU 32 of control device 3D reduces the transmission power of the wireless base station of interest, avoiding overlapping with the reachable range of transmission power at a wireless base station belonging to another domain. Therefore, the transmission power subsequent to reduction may be determined dynamically based on the distance from an adjacent wireless base station belonging to a domain differing from that of the wireless base station of interest and the transmission power of that adjacent wireless base station. Furthermore, a distance without interference (transmission power) from an adjacent wireless base station may be determined in advance, and reduce the transmission power down to the defined value (for example, ½ the normal transmission power). Further alternatively, the transmission power may be set to zero (output stopped) so as to avoid interference completely with an adjacent wireless base station.

In contrast, when the wireless base stations identified at step SD112 have all been set as a wireless base station of interest (YES at step SD130), the transmission power adjustment process ends, and control proceeds to step SD150.

At step SD140, CPU 32 of control device 3D determines whether there is a wireless base station already having its transmission power adjusted (step SD140). When there is a wireless base station already having the transmission power adjusted (YES at step SD140), CPU 32 of control device 3D transmits an instruction designating restoration of the transmission power to the wireless base station already having its transmission power adjusted (step SD142). In other words, CPU 32 of control device 3D causes wireless communication system SYS3 to provide a normal communication area in association with recovery of the synchronizing signal generation accuracy. Based on the instruction designating restoration of the transmission power, CPU 32 of control device 3D updates the value of corresponding wireless base station 2 in transmission power management list 666 stored in data storage unit 48 (step SD144).

When there is not a wireless base station already having the transmission power adjusted (NO at step SD140), or subsequent to execution of step SD144, the transmission power restoration process ends, and control proceeds to step SD150.

At step SD150, another one of the plurality of domains connected is selected as the new domain of interest (step SD150). Then, the processing of steps SD 102 and et seq. is repeated.

<Modification>

The above-described fourth embodiment is based on a configuration in which, when transmission power is already currently adjusted for a wireless base station belonging to another domain, adjacent to the wireless base station of interest, a determination is made as to whether the transmission power of a wireless base station of interest is to be adjusted or not with the state of a wireless base station belonging to that another domain (transmission power subsequent to adjustment) being maintained. In addition to this processing, a determination can be made on an overall basis as to which wireless base station is to have its transmission power reduced, between a plurality of adjacent wireless base stations belonging to different domains.

Specifically, for example, the cell range of wireless base stations belonging to each domain is compared with each other, and the wireless base station whose transmission power is to be adjusted may be determined such that the change from the original cell range (service providing range) is smaller. Alternatively, the priority on the range where the service is to be provided continuously may be determined in advance, and the wireless base station corresponding to a service providing range of lower priority may be determined as the subject to have its transmission power reduced. Further alternatively, the number of users currently in conversation/communication at each domain may be compared, and the wireless base station belonging to the domain of fewer users may be determined as the subject to have its transmission power reduced.

Since the wireless communication system of the present embodiment shares a synchronizing signal generation unit generating a synchronizing signal among a plurality of wireless base stations, a GPS module of higher accuracy and reliability can be employed while suppressing the cost of the entire system.

Furthermore, the wireless communication system of the present embodiment allows the transmission power to be adjusted to suppress interference with respect to a wireless base station connected to another synchronizing signal generation unit even in the case where a signal from a satellite including time information (for example, GPS signal) cannot be received at the synchronizing signal generation unit due to some cause and the accuracy of the generated synchronizing signal cannot be maintained. As a result, the conversation and/or communication service can be continued to the best possible degree even in the case where the accuracy of the synchronizing signal is not ensured.

Furthermore, the wireless communication system of the present embodiment allows the transmission power of only the required wireless base station to be adjusted according to the transmission power state of an adjacent wireless base station. Therefore, the service of conversation and/or communication can be continued to the best possible degree over a wider range.

<Other Formats>

According to the present embodiment, there is provided a control method of a wireless communication system providing conversation/communication by a terminal device. The control method includes the steps of: each of a plurality of synchronizing signal generation units generating a synchronizing signal based on a signal from a satellite including time information; each of a plurality of wireless base stations adjusting, according to a synchronizing signal from one of the plurality of connected synchronizing signal generation units the transmission/reception timing with a terminal device according to a synchronizing signal; a control unit determining whether the accuracy of a synchronizing signal generated at any of the plurality of the synchronizing signal generation units is below a predetermined level; when the accuracy of the synchronizing signal is below a predetermined level, the control unit referring to the management unit managing information associated with an arrangement position of the wireless base station in the wireless communication system to determine whether there is, among other wireless base stations arranged adjacent to the wireless base station of interest connected to the synchronizing signal generation unit whose accuracy of the synchronizing signal is below the predetermined level, a wireless base station connected to a synchronizing signal generation unit differing from the relevant synchronizing signal generation unit; and when there is arranged adjacently a wireless base station connected to a synchronizing signal generation unit differing from the synchronizing signal generation unit whose accuracy of the synchronizing signal is below the predetermined level, the control unit instructing the wireless base station of interest to reduce the transmission power.

According to the present embodiment, there is also provided a control device of a wireless communication system providing conversation/communication by a terminal device. The control device is connected to a plurality of wireless base stations. Each of the wireless base stations is connected to at least one of the plurality of synchronizing signal generation units generating a synchronizing signal based on a signal from a satellite including time information to adjust the transmission/reception timing with a terminal device according to a synchronizing signal. The control device determines whether the accuracy of the synchronizing signal generated at any of at least one synchronizing signal generation unit is below a predetermined level, and when the accuracy of the synchronizing signal is below the predetermined level, refers to the management unit managing information associated with an arrangement position of the plurality of wireless base stations to determine whether there is, among other wireless base stations arranged adjacent to the wireless base station of interest connected to the synchronizing signal generation unit whose accuracy of the synchronizing signal is below the predetermined level, a wireless base station connected to a synchronizing signal generation unit differing from the relevant synchronizing signal generation unit, and when there is arranged adjacently a wireless base station connected to a synchronizing signal generation unit differing from the synchronizing signal generation unit whose accuracy of the synchronizing signal is below the predetermined level, instructs the wireless base station of interest to reduce the transmission power.

### Other Embodiments

A program for executing the control described in the flow can be provided according to an arbitrary method. Such a program can be sold/distributed as a recording medium recorded through a computer readable recording medium such as a flexible disk, CD-ROM (Compact Disk-Read Only Memory), ROM (Read Only Memory), RAM (Random Access Memory) or a memory card. The program can be provided by down loading through a network.

The program may invoke the required program module among the program module presented as a portion of the operating system (OS) of a computer at a predetermined timing in a predetermined array for execution. In this case, the aforementioned module is not included in the program per se, and the process is executed in cooperation with the OS. Such a program not including a module is included in the program of the present embodiment.

Furthermore, the program of the present embodiment may be incorporated as a portion of another program to be presented. Similarly in this case, the module in the aforementioned another program is not included in the program per se, and the process is executed in cooperation with another program. Such a program incorporated into another program may be included in the program of the present embodiment.

It is to be understood that the embodiments disclosed herein are only by way of example, and not to be taken by way of limitation. The scope of the present invention is not limited by the description of the embodiments set forth above, but rather by the terms of the appended claims, and is intended to include any modification within the scope and meaning equivalent to the terms of the claims.

### REFERENCE SIGNS LIST

2 wireless base station; 3C, 3D control device; 4A, 4B, 4C, 4D synchronizing signal generation unit; 5C, 5D master control unit; 6A, 6C server device; 6D server unit; 7 antenna; 8A, 8B, 8C signal line; 10A, 10C, 10D data line; 12 satellite; 20 control unit; 21, 32, 40, 50, 60 CPU; 22, 34, 41, 52, 62 RAM; 23, 36, 42, 54 ROM; 24 decoding circuit; 25 up converter; 26 transmission antenna; 27 down converter; 28 reception antenna; 30 terminal device; 43 module; 44, 45, 58, 68 internal bus; 48, 66 data storage unit; 202, 322, 502 synchronizing signal module; 204, 330, 510 data communication module; 206 control module; 208 network module; 210 data link module; 324, 406, 504 accuracy evaluation module; 326, 506 adjacent base station identification module; 328, 408, 508 instruction generation module; 332 transmission power management module; 402 synchronizing signal output module; 404 terminal information acquisition module; 662 domain list; 664 neighbor list; 666 transmission power management list; 29, 40, 56 synchronizing signal I/F; 30, 38, 57, 64 data communication I/F; 31 exchanger I/F; 44 communication I/F; SYS1, SYS2, SYS3, SYS4 wireless communication system.

1. A wireless communication system providing conversation/communication by a terminal device, comprising:
a plurality of synchronizing signal generation units, each generating a synchronizing signal based on a signal from a satellite including time information,
a plurality of wireless base stations, each connected to one of said plurality of synchronizing signal generation units, and adjusting transmission/reception timing with said terminal device according to said synchronizing signal, and
a management unit managing information associated with an arrangement position of said plurality of wireless base stations,
said synchronizing signal including information indicating generation accuracy of the synchronizing signal according to a reception state at said synchronizing signal generation unit,
each of said plurality of wireless base stations
determining whether accuracy of a synchronizing signal generated at a corresponding synchronizing signal generation unit is below a predetermined level,
when said accuracy of the synchronizing signal is below the predetermined level, referring to said management unit to determine whether there is, among other wireless base stations arranged adjacent to its own station, a wireless base station connected to a synchronizing signal generation unit differing from its own connected synchronizing signal generation unit, and
when there is a wireless base station connected to a synchronizing signal generation unit differing from its own connected synchronizing signal generation unit, reducing its own transmission power.

2. The wireless communication system according to claim 1, wherein each of said plurality of wireless base stations
determines whether the accuracy of the synchronizing signal generated at a corresponding synchronizing signal generation unit has recovered to a predetermined level, after falling below the predetermined level, and
when said accuracy of the synchronizing signal has recovered to the predetermined level, restoring its own reduced transmission power to a former level.

3. The wireless communication system according to claim 1, wherein each of said plurality of wireless base stations maintains its own transmission power when there is no wireless base station connected to a synchronizing signal generation unit differing from its own connected synchronizing signal generation unit.

4. The wireless communication system according to claim 1, wherein
said management unit includes
first information defining each wireless base station and another wireless base station adjacent to a relevant wireless base station in correspondence,
second information defining each synchronizing signal generation unit and a wireless base station connected to a relevant synchronizing signal generation unit in correspondence,
each of said plurality of wireless base stations identifies another wireless base station adjacent to its own station by referring to said first information in said management unit, and
identifies a synchronizing signal generation unit to which is connected the obtained another wireless base station adjacent to its own station by referring to said second information in said management unit.

5. The wireless communication system according to claim 1, wherein each of said plurality of wireless base stations reduces its own transmission power to avoid overlapping with a reachable range of transmission power of an adjacent wireless base station connected to a synchronizing signal generation unit differing from its own connected synchronizing signal generation unit.

6. A wireless communication system providing conversation/communication by a terminal device, comprising:
a synchronizing signal generation unit generating a synchronizing signal based on a signal from a satellite including time information,
a plurality of wireless base stations connected to said synchronizing signal generation unit, and adjusting transmission/reception timing with said terminal device according to said synchronizing signal, and
a control unit controlling transmission power of said plurality of wireless base stations,
said control unit
determining whether accuracy of a synchronizing signal generated at said synchronizing signal generation unit is below a predetermined level,
when said accuracy of the synchronizing signal is below the predetermined level, obtaining information indicating a communication state between a relevant wireless base station and a terminal device from each of said plurality of wireless base stations,
generating an instruction to adjust transmission power of each wireless base station by evaluating a degree of interference based on the obtained information indicating said communication state for each wireless base station.

7. The wireless communication system according to claim 6, wherein said control unit
instructs all together said plurality of wireless base stations to reduce transmission power when said accuracy of the synchronizing signal is below the predetermined level, and
instructs individually a wireless base station tolerable of the occurring degree of interference to increase transmission power.

8. The wireless communication system according to claim 7, wherein
said information indicating a communication state includes a carrier to interference and noise ratio (CINR value) and a received signal strength indicator (RSSI value),
said control unit determines that the occurring degree of interference is tolerable when said CINR value is larger than a first threshold value and said RSSI value is smaller than a second threshold value.

9. The wireless communication system according to claim 6, wherein said control unit
determines whether accuracy of a synchronizing signal generated at any of said plurality of synchronizing signal generation units has recovered to a predetermined level after falling below the predetermined level, and
when said accuracy of the synchronizing signal has recovered to the predetermined level, generates an instruction to restore the transmission power of, among wireless base stations connected to a synchronizing signal generation unit whose accuracy of the synchronizing signal has recovered to the predetermined level, a wireless base station instructed to have transmission power reduced.

10. A wireless communication system providing conversation/communication by a terminal device, comprising:
a plurality of synchronizing signal generation units, each generating a synchronizing signal based on a signal from a satellite including time information,
a plurality of wireless base stations, each connected to one of said plurality of synchronizing signal generation units, and adjusting transmission/reception timing with said terminal device according to said synchronizing signal,
a management unit managing information associated with an arrangement position of said plurality of wireless base stations, and
at least one control unit controlling transmission power of said plurality of wireless base stations,
said control unit
determining whether accuracy of a synchronizing signal generated at any of said plurality of synchronizing signal generation units is below a predetermined level, and
when said accuracy of a synchronizing signal is below the predetermined level, referring to said management unit to determine whether there is, among other wireless base stations arranged adjacent to a wireless base station of interest connected to a synchronizing signal generation unit whose accuracy of the synchronizing signal is below the predetermined level, a wireless base station connected to a synchronizing signal generation unit differing from a relevant synchronizing signal generation unit, and
when there is arranged adjacently a wireless base station connected to a synchronizing signal generation unit differing from the synchronizing signal generation unit whose accuracy of the synchronizing signal is below the predetermined level instructing the wireless base station of interest to reduce transmission power.

11. The wireless communication system according to claim 10, wherein said control unit
determines whether the accuracy of a synchronizing signal generated at any of said plurality of synchronizing signal generation units has recovered to a predetermined level, after falling below the predetermined level, and
when said accuracy of a synchronizing signal has recovered to the predetermined level, instructing a wireless base station instructed to have power transmission reduced to restore the transmission power, among wireless base stations connected to a synchronizing signal generation unit whose accuracy of the synchronizing signal has recovered to the predetermined level.

12. The wireless communication system according to claim 10, wherein said control unit maintains, when there is not arranged adjacently a wireless base station connected to a synchronizing signal generation unit differing from the synchronizing signal generation unit whose accuracy of the synchronizing signal is below the predetermined level, the transmission power of said wireless base station of interest.

13. The wireless communication system according to claim 10, wherein said management unit includes
first information defining each wireless base station and another wireless base station adjacent to a relevant wireless base station in correspondence,
second information defining each synchronizing signal generation unit and a wireless base station connected to a relevant synchronizing signal generation unit in correspondence,
wherein said control unit identifies
another wireless base station adjacent to said wireless base station of interest by referring to said first information in said management unit, and
a synchronizing signal generation unit to which is connected the obtained another wireless base station adjacent to the wireless base station of interest by referring to said second information in said management unit.

14. The wireless communication system according to claim 10, wherein said control unit reduces power transmission of the wireless base station of interest such that a reachable range of transmission power at the wireless base station of interest does not overlap with the reachable range of transmission power of an adjacent wireless base station connected to a synchronizing signal generation unit differing from the wireless base station of interest.

15. The wireless communication system according to claim 10, wherein said control unit
when there is arranged adjacently a wireless base station connected to a synchronizing signal generation unit differing from the synchronizing signal generation unit whose accuracy of the synchronizing signal is below the predetermined level, determines whether the wireless base station arranged adjacently is already instructed to reduce transmission power, and
when the wireless base station arranged adjacently is already instructed to reduce transmission power, maintains the transmission power of the wireless base station of interest.
